(19) United States
(12) Patent Application Publication
(10) Pub. No.: US 2026/0200312 A1
(43) Pub. Date: Jul. 16, 2026

(54) A Gaseous Fuel Storage System for a Working Machine

(71) Applicant: J.C. BAMFORD EXCAVATORS LIMITED, Uttoxeter (GB)

(72) Inventor: Tom Rushton, Uttoxeter (GB)

(21) Appl. No.: 19/134,623

(22) PCT Filed: Dec. 1, 2023
(86) PCT No.: PCT/GB2023/053116

§ 371 Date: May 30, 2025

(30) Foreign Application Priority Data
Dec. 1, 2022 (GB) 2218106.9

(51) Int. Cl. B60K 15/03; B60K 15/063

(52) U.S. Cl. CPC B60K 15/03006; B60K 15/063; B60K 2015/03019; B60K 2015/03315; B60K 2015/0634; B60Y 2200/20

(57) ABSTRACT

An off-highway machine including: a body mounted on a ground engaging structure; a gas engine; an array of storage tanks for supplying gaseous fuel to the gas engine, each storage tank including a cylinder having a central axis, a first end and a second end, and oriented such that first end of each storage tank is provided on the same side of the array, wherein each first end of the storage tanks is provided with a tank valve for controlling the flow of gaseous fuel into and out of the respective cylinder, wherein the tank valves of the respective storage tanks are connected in series flow communication such that a first of the plurality storage tanks comprises a first tank valve inlet in flow communication with a filling nozzle inlet, and a first tank valve outlet is connected to a second tank valve inlet of an adjacent tank in the array of tanks.

### FIELD

This invention relates to a working machine. In particular, though not exclusively, the invention relates to a material handling machine having a pivoting telescopic working arm.

### BACKGROUND

Off-highway vehicles/working machines are typically those used in construction industries (e.g., backhoe loaders, slew excavators, telescopic handlers, forklifts, skid-steer loaders, dump trucks, bulldozers, graders), agricultural industries (e.g., tractors, combine harvesters, wheeled loading shovels, telescopic handlers, self-propelled harvesters and sprayers), quarrying (e.g., excavators, wheeled loading shovels, aggregate crushing equipment), and forestry (e.g., timber harvesters, feller bunchers). Many working machines have a primary function of moving material using either a lifting arm (e.g., a pivoting boom) or a working arm (e.g., an excavator arm) and may be referred to as material handling machines.

Telehandlers are generally well known and comprise a vehicle with a pivoting telescopically extending working arm which allows items to be transported between different locations at varying heights with relative ease and flexibility. Telehandlers are often utilized in agriculture, construction or logistics, amongst other sectors.

Conventionally, working machines of the type referred to above are generally powered by diesel internal combustion engines. However, there is a general need to reduce vehicle emissions in the face of global warming leading to working machine OEMs considering alternative prime movers. Proposed alternatives include battery, hydrogen fuel cells, hydrogen internal combustion engines and various hybrid options, etc.

The present invention seeks to provide a storage solution for a gaseous fuel for a working machine comprising a gas engine.

### SUMMARY

The present invention provides a material handling machine according to the appended claims.

In a first aspect, the present disclosure provides a material handling machine comprising: a body mounted on a ground engaging structure; a telescopic lifting arm pivotally mounted to the body; an operator cab mounted to the body adjacent the telescopic arm; and at least one storage tank for receiving a gaseous fuel. The storage tank may be located beneath the operator cab. The material handling machine may comprise a gas engine configured to provide motive power to the ground engaging structure and/or to a hydraulic pump. The gas engine may be fueled exclusively by hydrogen.

Providing the storage tank below the operator cab may provide a convenient location for storing a gaseous fuel. The location of the storage tanks may be fully underneath the operators cab thereby providing natural protection. The storage tank may be located fully within the footprint of the operator cab.

The storage tank may comprise a cylinder having a central axis, a first end and a second end. The storage tank may be torpedo shaped such that the first and second end are provided by rounded, e.g., hemispherical, caps on the end of a cylindrical body.

The principal central axis, e.g., the longitudinal axis, of the storage tank may be arranged transverse, optionally perpendicular, to a principal longitudinal axis of the machine. The central axis may be arranged transverse to the forward facing direction of the cab. In other words, the storage tank may extend across a portion of the machine and/or across an underside of the operator cab. It will be appreciated that the central axis may be a longitudinal axis of the storage tank.

The body of the material handling machine may comprise a front, a rear, lifting arm side proximate to the lifting arm and an operators cab side which correspond to the front, rear and respective sides of the machine. The first end of the storage tank may be provided adjacent to the cab side of the material handling machine.

The material handling machine may comprise a tank assembly. The tank assembly may comprise one or more storage tanks and a bulkhead from which the storage tank(s) is suspended. The tank assembly may additionally comprise one or more taken from the group comprising: one or more tank valves, gas lines e.g., pipes/conduits, a filling nozzle inlet, an outlet regulator and a housing (or part thereof) in which the storage tank(s) is located.

The storage tank may comprise one or more valves located at the first end of the tank such that the one or more valves or associated pipework is provided adjacent to the cab side of the machine to allow for convenient maintenance and inspection.

The storage tank may comprise a plurality of storage tanks laterally distributed so as to be located side-by-side. The plurality of storage tanks may be arranged parallel to one another. The plurality of tanks may each include a first end and a second end and lie in a common orientation such that the first ends are collocated. The tanks may be similar to one another having the same dimensions and/or the same storage capacity.

The storage tanks may be located within a housing. The housing may comprise a bulkhead located between the storage tank and the operator's cab. The housing may comprise at least one side wall extending downwardly from the bulkhead.

The bulkhead and at least one side wall may be sealably connected to one another to prevent an uncontrolled escape of gaseous fuel from the storage tank towards the operator cab. The bulkhead and at least one side wall may engage via a flexible seal. The flexible seal may be a peripheral seal which is provided around an edge of the bulkhead. The peripheral seal may be a bubble seal and may be compressed by the side wall in situ.

The flexible seal may be suitable for allowing sealed relative movement between the bulkhead and side wall in use. The side wall may be mounted to a chassis of the machine independently of the bulkhead.

The bulkhead may comprise one or more elevated portions to provide a pocket into which escaped gas can flow and be directed to a safe vent. The elevated portion may be provided at a central region of the bulkhead. As such, the elevated portion may be flanked by one or more lower portions. In some embodiments of the present disclosure, the elevated portion may be aligned with the central axis of the storage tank. The elevated portion may extend only partially over the width of the storage tank. Where there are multiple storage tanks, the elevated portion may extend only over one of the storage tanks. The elevated portion may be configured to receive a portion of one of the storage tanks.

The housing may provide a substantially sealed space such that escaped gaseous fuel cannot unintentionally enter the operator cab. In order to vent the housing, the elevated portion may comprise a vent outlet. The housing vent outlet may be configured to vent the interior of the housing to atmosphere away from the operator cab. The housing vent outlet may be a passive vent comprising an aperture in a wall of the housing which is sealably connected to a corresponding vent pipe. The vent pipe may terminate in a vent pipe outlet located in a suitable location remote from the operator cab.

The housing vent outlet may be provided on an inboard side of the machine. The housing vent outlet may be provided on a front surface of the tank housing and/or inboard of the bulkhead so as to be proximal to the chassis sidewall. In some embodiments, the chassis side wall may form a wall of the housing and may simply comprise an aperture located towards or at an upper edge of the housing to provide the vent outlet. The chassis side wall may comprise an aperture in fluid communication with the elevated portion of the bulkhead.

The housing vent outlet may comprise a vent pipe. The vent pipe may extend between the elevated portion and an aperture in the side wall of the chassis.

The plurality of storage tanks may comprise an array of tanks with at least one central tank being provided at an elevated position relative to the adjacent tanks. Providing a central tank with a vertical offset in this way may allow the tanks to be positioned laterally closer together in a side-by-side relation. Thus there is provided a way of helping to maximize the volume of stored gas on the working machine as the storage tanks need room to expand and may have minimum clearances that need to be maintained between each tank and the tanks and the bodywork panels. The central tank may be provided within the elevated portion.

The storage tank(s) may be suspended from the bulkhead. Thus, the bulkhead may be a structural member with sufficient strength and rigidity to support the weights of the tanks underneath the operator cab. The suspension from the bulkhead may incorporate one or more shock absorption elements to help isolate the storage system from the movement, e.g., vibration, of the machine.

The storage tank may be attached to the bulkhead using one or more suitable fixings such as a strap which extends circumferentially around the tank. The or each storage tank may comprise a pair of straps provided along the length of the tank. The or each storage tank may be received in a suitable saddle which corresponds to the external shape of the or each storage tank. In some embodiments, the or each storage tank may be mounted via a neck portion. The neck portion may be adjacent a tank valve.

The body of the machine may comprise a chassis. The chassis may provide the main structural element of the machine. The chassis may be carried by the ground engaging structure, e.g., the axles and/or wheels, and may provide support for a prime mover, bodywork, drivetrain, lifting arm and operators cab, for example. The chassis may comprise a lifting arm housing in which the lifting arm is partially housed when in a non-working position and/or provides a pivoting mount for the lifting arm. A side wall of the lifting arm housing may be adjacent and proximate to the operator cab. The chassis may comprise a cab support structure on which the cab is mounted.

The bulkhead may be attached to the cab support structure. In some embodiments of the present disclosure, the cab support structure may comprise a pair of cantilevered arms which extend from a main part of the chassis. The cantilevered arms may comprise a fixed end attached to the chassis and a free end which is located towards the cab side of the machine. The cantilevers may be appended to the chassis sidewall. In some embodiments, the bulkhead may be directly attached to or form part of the operator's cab floor.

The cantilevered arms may comprise a horizontal base and a pair of side walls extending upwardly from the base. The side walls may be inclined away from vertical and outwardly from a center of the base. The inclination of the side walls may provide the cantilevers with a trough-like profiled with angled sides. The cantilevers may further comprise one or more gusset plates onto which the operator cab is fixed. In some embodiments, the cantilever arms may comprise box sections having upper and lower walls with side walls extending therebetween to enclose an internal volume. The box section may comprise angled side walls. The box section may comprise a trapezoid.

Providing cantilevers with inclined side walls provides a synergistic benefit in that the depth of the cantilevers may be reduced whilst providing suitable levels of support for the operator cab and storage tank assembly.

The cantilevers may be located fore and aft in relation to the operator cab and may be spaced from one another. A portion of one or more of the storage tanks may be located between the cantilever arms. The elevated portion of the bulkhead may be located between the cantilever arms, thereby utilizing the space between the operator cab supports and space beneath the operator cab. This is particularly advantageous where the elevated portion houses a portion of one of the storage tanks.

The housing vent pipe may comprise a square section and/or has a flow area of at least 0.0015 m\hat{ }2. Providing a square cross section, e.g., rectangular or square, allows the size of the vent to be increased. The vent pipe may, for example, comprise a pipe having a cross-section of between 100 mm and 200 mm wide by 40 mm by 200 mm deep, or any combination of dimensions or a diameter within those ranges. In some embodiments, the vent pipe may comprise a round section, e.g., circular.

The machine may comprise one or more gas sensors for detecting the presence of escaped gaseous fuel in the housing. The gas sensor may be configured to sense or detect a concentration of escaped gas. The gas sensor may be provided on or in the housing. In some embodiments, the gas sensor is located within the housing, optionally, on or in the elevated portion.

The machine may comprise a controller for receiving an input signal from the gas sensor. The input signal may be indicative of a concentration of escaped gaseous fuel within the housing. The controller may be configured to provide an operator with a warning when the concentration of escaped gaseous fuel is above a first threshold. The first threshold may be indicative of a potentially leak.

In some embodiments, the controller may be provided with a second threshold. The second threshold may be higher than the first threshold and be indicative of a concentration of escaped gas which requires action from the operator. The action may be a precautionary shutdown of the engine or a maintenance schedule. In some embodiments, the controller may be configured to activate a purge of the housing, isolate the storage tank(s) or shut down the machine automatically where the first, second or a further threshold is reached. The first threshold may correspond to a gaseous fuel concentration of 1% or more. The second threshold may correspond to between 2% and 3% and may result in a purge of the housing. A third threshold may correspond to a concentration above 3% or above 3.5% or 4% and may result in the engine and/or gas storage tank(s) or the associated system being shut down.

The operator warning may comprise one or more of a visual, audible or haptic output within the operator cab. For example, the operator warning may comprise the illumination of one or more LEDs located in a prominent location in the operator cab or on a display screen or the like. The audible operator warning may comprise a speaker or buzzer sounding within the operator cab.

The storage tank housing may comprise an air inlet for receiving air via a blower unit configured to provide an external air flow through the housing so as to purge any escaped gaseous fuel. Thus, in the event of a gaseous fuel leak within the housing, the air may be purged using air drawn in from outside of the housing. The vent and air inlet may be positioned to assist a natural upward flow of escaped gaseous fuel. Hence, the air inlet may be provided below the vent. The air inlet may be provided towards a lowermost location in the housing, e.g., in or towards the base. The vent may be provided uppermost.

Blowing or drawing in external air to provide positive pressure within the housing is preferrable to sucking air and gaseous fuel out as the risk of ignition from the blower unit is reduced. Further, it allows the blower unit to be located towards the bottom of the housing where escaped gas, e.g., hydrogen, is less likely to collect due to its low density.

The housing may comprise a base wall. The blower unit may be located in or adjacent to the base wall. In some embodiments of the present disclosure, the housing may comprise an angled or chamfered wall portion which extends at an angle between the base wall and rear side wall which may accommodate the blower unit inlet. Providing the blower unit in the chamfered wall portion allows the inlet to be placed lowermost in the housing whilst facing rearwards to avoid fluid and/or debris from the ground. The chamfered wall portion may be referred to as part of the base wall in some embodiments. In some embodiments, an inlet duct (not shown) may be provided upstream of the air inlet and/or blower unit. The inlet duct may be arranged to provide a separation or prevent a direct line of sight between the exterior of the housing and the blower unit. The inlet duct may comprise an inlet provided at a first side of the housing with the housing inlet and/or blower unit being provided at an opposing side. The inlet duct may be arranged along or incorporate the base wall of the housing.

The controller may be further configured to activate the blower unit when the sensed escaped gaseous fuel is above a first evacuation threshold. The controller may be configured to isolate the storage tank and/or shut the machine down when the concentration is above the first evacuation threshold.

In a second aspect the present disclosure may provide a material handling machine comprising: a body mounted on a ground engaging structure; a telescopic lifting arm pivotally mounted to the body; an operator cab mounted to the body adjacent the telescopic arm; and a plurality of steps located beneath an entrance to the operator cab to facilitate access; and, a plurality of storage tanks for receiving a gaseous fuel, wherein the storage tanks are located beneath the operator cab and laterally distributed so as to sit side-by-side beneath the floor of the operator cab, wherein the plurality of storage tanks are located behind the plurality of steps.

The material handling machine may comprise a gas engine configured to provide motive power to the ground engaging structure and/or to a hydraulic pump. The gas engine may be fueled exclusively by hydrogen.

The material handling machine may further comprise a housing in which the storage tanks are located. The housing may comprise an external wall, wherein the plurality of steps are provided within pockets within the external wall. The pockets may be closed wall pockets each having a tread plate for receiving an operator's foot therein. The closed wall pockets may comprise a back wall, a first side wall, a second side wall, an upper wall and a base wall. The walls of the step pockets may be joined such that the recess in which an operator's foot is received is sealably partitioned from the interior of the housing. Depending on the arrangement of the step pockets in relation to the housing, one or more of the step pockets may not include one or more of the various walls. For example, where a step pocket is provided lowermost in the housing, there may be no need for the base wall, the base of the step pocket instead being provided by the tread plate.

The plurality of steps may comprise a first step pocket and a second step pocket. The first and second step pockets may be laterally separated. The first step pocket may be provided towards the front of the operator cab relative to the second step pocket. The space between the first step pocket and second step pocket may be comprise an external wall of the housing. The separation between the first and second step pocket may be greater than the width of either of the first or second step pocket. The separation of the first or second step pocket may be between 100 mm and 500 mm. Where the first step pocket and the second step pocket are provided at different heights, the lateral separation may be less than 500 mm.

The laterally separated step pockets may be provided at different heights. Thus, the first step pocket may be a lower step and the second step pocket may be an upper step. In other embodiments, the first step pocket and the second step pocket may be provided at a common height and with an additional step pocket being provided above or below the first and second step pockets. Hence, there may be a single lower step and two upper steps which are laterally separated, or vice versa. In some embodiments there may be a single lower step and a single upper step. Where the laterally separated steps are provided at different heights, the lateral separation may be with respect to the centerline of each step. Where the laterally separated steps are at a common height, lateral separation may be with respect to the opposing lateral edges of the steps such that the steps are horizontally separated by a gap.

The first step pocket and second step pocket may be provided at a common height. Thus, the tread plate of each of the first and second steps may be at the same vertical separation from a nominal ground surface and/or the floor of the operator cab. Hence, the first step pocket and second step pocket comprise an upper step in which either or both of the first step pocket and second step pocket may be used individually by an operator. The first and second step pockets may comprise a width of between 150 mm and 300 mm, optionally between 150 mm and 250 mm, and a depth (into the housing) of between 100 mm and 200 mm, optionally 140 mm to 150 mm. The first step and second step pockets may be similarly dimensioned. The height of the step pockets may be between 150 mm and 225 mm, optionally between 160 mm and 190 mm.

The lower step may comprise a single step pocket. Hence, the steps may comprise a pair of upper steps and a single lower step. The lower step may extend laterally beyond the inner edges of the first step pocket and second step pocket. In other words, the lower step may be wider than the separation of the upper steps and may be centered on the midline between the upper steps. The arrangement of the first step and second steps may be symmetrical about a vertical midline.

Where a single step pocket is provided at a given height, such as a single lower step, the step may have a width of between 300 mm and 500 mm, optionally between 400 mm and 450 mm. The depth of the single step pocket may be between 100 mm and 200 mm, optionally 140 mm to 150 mm. The height of the single step pocket may be the same as the first and second step pockets. The height of the single step pocket may be between 150 mm and 225 mm, optionally between 160 mm and 190 mm.

The step pockets may project into the housing. The lateral separation of the first step pocket and the second step pocket may define an internal recess therebetween within the housing. A portion of at least one of the plurality of storage tanks may be located within the internal recess. In some embodiments of the present disclosure a tank valve of the at least one of the plurality of storage tanks may be located between the first step pocket and the second step pocket.

Separating a step at a given height into to laterally separated steps provides a space into which a part of a storage tank, for example a valve and/or an end portion of the tank, can be received, thereby allowing the tanks to be packaged below the operator cab more favorably. The separation of the steps may, additionally or alternatively, provide a location in which gas lines or other pipes or conduits of the storage system may be located.

The plurality of storage tanks may comprise at least two storage tanks, or at least three storage tanks. One of the tanks, for example, a central tank of the plurality of tanks may be located within the internal recess. The central tank may be positioned vertically higher than one or more adjacent side tanks of the plurality of tanks. The lower step pocket may be provided below the central tank. The vertically higher position of the central tank may allow the lower step pocket to be positioned more favorably in relation to the operator cab and/or the upper steps.

The step pockets, or the treadplates thereof, may be vertically evenly spaced. The lowest step in the plurality of steps may be between 400 mm and 600 mm from a nominal ground surface, as defined by a plane extending between the front and rear wheels.

The housing may comprise a bulkhead above the plurality of storage tanks. The bulkhead may comprise an elevated portion in which the central tank is at least partially located.

The housing may have an external cab side wall with a width (as viewed from the side of the machine) of between 0.8 m and 1.8 m, optionally between 1 m and 1.5 m, optionally between 1.2 m and 1.3 m. The external cab side wall may comprise a height of between 400 mm and 1000 mm, optionally between 450 mm and 700 mm, optionally between 500 mm and 600 mm.

The footprint area of the housing may correspond to or be larger than the footprint area of the cab.

At least one of the first or second step pockets may be located between adjacent tanks. In some embodiments of the present disclosure, the tanks may comprise rounded, e.g., hemispherical, ends and the step pockets may project into the housing and be located adjacent the hemispherical end caps of two adjacent storage tanks. The respective tank valves of the adjacent tanks may be proximal to a side wall of the step pockets. The lateral separation between the adjacent tank valves may be greater than the lateral separation between the side walls of the first step pocket or second step pocket.

Where there are three tanks, the lateral separation between the two outside tank valves may be greater than the lateral separation of the side walls of the lower step pocket.

The material handling machine may further comprise a chassis. The chassis may comprise an operator cab support structure on which the operator cab is mounted. The plurality of steps may comprise a sub-assembly which is attached to and supported by the cab support structure and/or the operator cab. The sub-assembly may comprise first and second lateral support members. Each lateral support member may attach to a side wall of at least one step pocket. The sub-assembly may further comprise at least one central member. The central member may extend between opposing walls of adjacent step pockets. The lateral support member(s) and/or central support member may attach to the cab support structures. The lateral and/or central support member may be attached to the cantilevers of the cab support structure. The attachment between the step pockets and lateral support member(s) or central member(s) may be achieved using conventional means such as a nut and bolt arrangement or welding.

The material handling machine may further comprise three or more step pockets arranged in a triangular configuration with each step pocket comprising an external pocket wall on the external side of the triangular configuration. The lateral support member(s) may extend between external pocket walls of adjacent step pockets. Each step pocket may comprise at least one internal pocket wall on an internal side of the triangular configuration. The central member may extend between internal pocket walls of adjacent step pockets. The internal pocket walls may be a sidewall, base or upper wall of the step pocket.

The central member may extend between the opposing side walls of the first and second step pocket and the upper wall of the lower step pocket.

The housing may be attached to the operator cab support structure separately from the step sub-assembly. The housing may additionally or alternatively be attached to a chassis side wall. The housing and step sub-assembly may abut one another via a seal member. The seal member may comprise a compressible seal member.

The housing side wall may comprise an upper portion located immediately below the operator cab and above the bulkhead. The upper wall may comprise one or more air vents to allow escaped gas to be vented to atmosphere. The air vents may be fluid communication with a void located between the operator cab and bulkhead.

The housing side wall which comprises the plurality of steps may be vertically oriented such that the steps are not readily viewable from the operator's cab. As such, an operator may not be able to see the steps when exiting the cab and may not be able to view where to put their feet. An upward facing wall portion of the housing may be provided immediately above at least one of the plurality of steps. The upward facing wall portion may be located directly above one of the step pockets may be provided with one or more markings to indicate where the step pockets are located. The one or more markings may comprise the air vents such that the position of the one or more air vents is indicative of the position of the step. As the markings and/or air vents are provided on an upward facing portion of the housing, they may be presented by an operator exiting the cab, thereby facilitating location of the feet. The markings may comprise grit-strips, decals or lighting in some embodiments.

In a third aspect of the present disclosure there is provided an off-highway machine comprising a body mounted on a ground engaging structure and an array of storage tanks for receiving a gaseous fuel within the body. Each storage tank may comprise a cylinder having a central axis, a first end and a second end, and oriented such that first end of each storage tank is provided on the same side of the array. Each first end of the storage tanks may be provided with a tank valve for controlling the flow of gaseous fuel into and out of the respective cylinder. The tank valves of the respective storage tanks may be connected in series flow communication such that a first of the plurality storage tank comprises a first tank valve inlet in flow communication with a filling nozzle inlet. A first tank valve outlet is connected to a second tank valve inlet of an adjacent tank in the array of tanks.

The material handling machine may comprise a gas engine configured to provide motive power to the ground engaging structure and/or to a hydraulic pump. The gas engine may be fueled exclusively by hydrogen.

The machine may further comprise a plurality of ports. A first port of the plurality of ports and a second port of the plurality of ports may each be attached to either an inlet conduit or an outlet conduit for receiving and delivering gaseous fuel to and from the storage tank respectively. The first portion may be provided in a first port position and the second port may be provided in a second port position. The first port position and second position may correspond across the plurality of tank valves.

The first port and second port may be configurable as an inlet port or an outlet port such that the position of the inlet conduit and outlet conduit can be selected.

In some embodiments, the tank valves are the same on each tank in as much as they have corresponding port positions. Each valve may be orientated in a similar manner such that the first port and second port of each valve is provided in the same location. In some embodiments, the first port and second port may be configured differently between different valves. Hence, the first port may be an inlet port on a first tank valve, and an outlet on a second tank valve.

For a first tank of the array of tanks, the first port may be an inlet port and the second port is an outlet port. For a second tank of the array of tanks, which is in adjacent flow communication with the first tank, the first port may be an outlet port and the second port is may be inlet port. By alternating the inlet and outlet positions in adjacent tanks, it allows the interconnecting conduits in the series connection to be simplified as the connection points stay on the same side of the tank valves. Directly connected ports of adjacent tanks may be provided on corresponding sides of the tank valves such that, for example, interconnected ports are provided on above or below the tank valves to allow them to be more readily connected with a minimum length and minimum cross-overs with other lines. That is, the ports may be aligned so that the gas lines enter from the same direction to simplify assembly.

The storage tank system may comprise a filling nozzle inlet. The filling nozzle inlet may be configured to receive a refueling nozzle from a suitable source of gaseous fuel. The filling nozzle inlet may be located in an external wall of the storage tank housing. The filling nozzle inlet may be located adjacent to or proximate the first tank. The first tank may be defined by the tank being connected to the filling nozzle inlet. The proximal location of the first tank and filling nozzle inlet may be with respect to the other storage tanks.

The filling nozzle inlet may be located behind a hinged door provided in the storage tank housing. The housing may comprise a nozzle support structure for receiving and supporting the nozzle of the refueling device during refueling. The nozzle support structure may comprise a shelf, saddle or collar with which the filling nozzle can engage so as to be supported during the filling process. The door which covers the filling nozzle inlet may comprise the nozzle support structure.

The machine may further comprise an outlet regulator connected to the outlet of a final tank in the series of tanks. The outlet regulator may be configured to receive the gaseous fuel from the storage tanks and regulate the pressure prior to delivery to the prime mover. The outlet regulator may be proximate to the final tank in the series of storage tanks.

Each of the tanks may comprise an angular location feature configured to ensure the tanks and tank valves are mounted in the correct angular orientation relative to one another. In doing so, it is possible to mount similar tank valves to the storage tanks prior to attaching them to the bulkhead and easily orientate them so that the valves are orientated in a desired position with the ports provided in positions which make the connection of the interlinking conduits easier. The location feature may additionally or alternatively provide axial alignment for each of the storage tanks.

Each tank may comprise a temperature dependent pressure relief device, TPRD. The TRPD may be located anywhere on the tank but may advantageously be provided on the tank valve.

The TPRD may be configured to act as a temperature responsive valve which fully opens to vent the content of the storage tanks in the event of a fire. The TRPDs may be thought of as acting like a fuse which blows when a fire is present to prevent pressure build up in the tanks.

In addition to the TRPD, the tank valves may include a pressure relief valve which is pressure responsive and configured to open when an internal pressure of the tank reaches a predetermined threshold valve such that the gaseous fuel can be safely vented to atmosphere.

The TRPDs may be connected to a tank vent conduit. The tank vent conduit may extend from each respective TRPD to a tank vent outlet remote from the plurality of storage tanks. Each storage tank valve may be connected to a common tank vent conduit which terminates in a tank vent outlet remote from the storage tanks. The TRPDs may be connected in series flow communication or a radial connection with the individual vent lines being connected to a common tank vent conduit.

The TRPDs may be provided at the same location on each tank. In doing so, the connection and routing of the tank vent conduits may be simplified.

The outlet regulator may comprise a pressure relief valve connected to the common tank vent conduit. The outlet regulator vent conduit may be linked in series with the tank vent conduits.

The tank vent outlet may be provided above a body of the working machine such that it can vent unobstructed to open air. The tank vent outlet may be provided above the operator cab and/or be the highest point on the machine. The tank vent outlet may be provided at an inboard portion of the machine and, in some embodiments, towards a central location. Providing the tank vent outlet towards a central location of the machine helps reduce the risk of ignition from ignition sources which are external to the machine. Where the working machine comprises a working arm, e.g., a lifting or excavating arm, the tank vent outlet may be located inboard of the arm. Further, the inboard location of the tank vent outlet may help guard against collision with foreign objects such as tree branches or other overhanging hazards which may be present.

The central location may be on or adjacent to the longitudinal centerline of the machine. The central location may be within a region which is 30%, optionally, 25%, optionally 20%, optionally 10% of the machine width from the longitudinal centerline.

The central location may be between the first and second axle. The central location may be between the fore-aft extremities of the operator cab. The central location may be within a region which is 30%, optionally, 25%, optionally 20% of the machine length from the transverse centerline.

In some embodiments, the tank vent outlet may be provided on an inboard side of the cab. The tank vent conduit may extend up a front or rear support member of the operator cab, for example a corner pillar which supports the roof. Hence, the tank vent conduit may extend up an inboard fore or aft pillar.

The tank vent conduit may comprise one or more flexible portions and one or more rigid portions. The rigid portions may extend up the operator cab and/or along the body and/or chassis. The flexible portion(s) may extend between the storage tanks or a housing thereof to the body and/or operator cab and/or chassis to allow differential movement of the plurality of storage tanks and the body and/or operator cab and/or chassis.

The or each tank valve may comprise one or more of the group comprising: a shut-off valve, a pressure transducer, a temperature sensor and a temperature pressure relief device, a first port and a second port. In some embodiments of the present disclosure the first port may be an inlet port and the second port may be an outlet port. In some embodiments, the first port and second port may be configurable to be an inlet port with the other being an outlet port. As such, the first and second ports may be unidirectional ports such that they can either receive or deliver gaseous fuel.

The present disclosure may provide a gas engine storage arrangement for storing a quantity of gas for use by the gas engine. The storage arrangement may comprise at least one vent line which terminates in a vent outlet and is configured to convey escaped gas from one or more storage tanks to the vent outlet. The vent outlet may comprise a cap. The cap may be configured to be removed, e.g., blown off, from the vent outlet with a predetermined gas flow. In some embodiments, the cap may be configured to move axially outwards to allow gas to escape whilst being retained within the vent outlet. Thus the cap may comprise a retention feature which prevent removal of the cap during venting.

The cap may comprise an aperture into which a portion of the vent outlet is received. The portion of the vent outlet may be loosely received such that there is a leakage flow may past the cap whilst in situ.

The cap may comprise a body and the aperture may be provided in an underside of the body. The aperture may be a blind aperture.

The vent outlet may comprise a terminal end of the vent line.

The cap may comprise a tether to couple the cap to the vent outlet, vent line or an adjacent structure in the event that the cap is removed.

The cap may be configured to be highly visible. The cap may comprise high visibility markings or colors.

The cap may be applicable to vent lines for gas storage assemblies generally and not necessarily those provided on working machines.

The storage arrangement may be used with a working machine or a genset. The genset may comprise the gas engine and at least one electrical generator.

The present disclosure comprises a method of inspecting the material handling machine having a vent line outlet comprising a removable cap. The method may comprise inspecting the vent line outlet to determine if the removable cap has been removed and, if the cap has been removed, determining that a leak has occurred.

The material handling machine may be any working machine configured to handle a load with a working arm such as a wheeled shovel loader, a backhoe loader, an excavator, a skid steer, an industrial forklift or a roto. In preferred embodiments, the material handling machine is a telehandler.

The skilled person will appreciate that except where mutually exclusive, a feature described in relation to any one of the aspects, embodiments or examples described herein may be applied mutatis mutandis to any other aspect, embodiment or example. Furthermore, except where mutually exclusive, any feature described herein may be applied to any aspect and/or combined with any other feature described herein.

### BRIEF DESCRIPTION OF DRAWINGS

Embodiments will now be described by way of example only with reference to the accompanying figures, in which:

FIGS. 1a to 1e show a working machine according to the present disclosure. Thus, there is shown a front perspective view of the lifting arm side (FIG. 1a), a rear perspective view of the lifting arm side (FIG. 1b), cab side sideview (FIG. 1c), a lifting arm sideview (FIG. 1d), a front perspective view of the cab side (FIG. 1d) and a rear perspective view of the cab side;

FIGS. 2a and 2b show a rear perspective view and a top-down side view of a step arrangement according to the present disclosure;

FIGS. 3a and 3b show rear perspective and front perspective view of the step arrangement of FIGS. 2a and 2b with an outer housing removed;

FIG. 4 shows a plurality of storage tanks located beneath an operator cab according to an embodiment of the present disclosure;

FIGS. 5a and 5b shows the storage tanks of FIG. 4;

FIG. 6 shows a cap for closing a tank vent outlet;

FIG. 7 shows a storage location of a battery according to the present disclosure;

FIG. 8 shows an alternative storage location of a battery according to the present disclosure.

### DETAILED DESCRIPTION

In the following detailed description, numerous specific details are set forth in order to provide a thorough understanding of various embodiments and the inventive concept. However, those skilled in the art will understand that: the present invention may be practiced without these specific details or with known equivalents of these specific details; that the present invention is not limited to the described embodiments; and, that the present invention may be practiced in a variety of alternative embodiments. It will also be appreciated that well known methods, procedures, components, and systems may not have been described in detail.

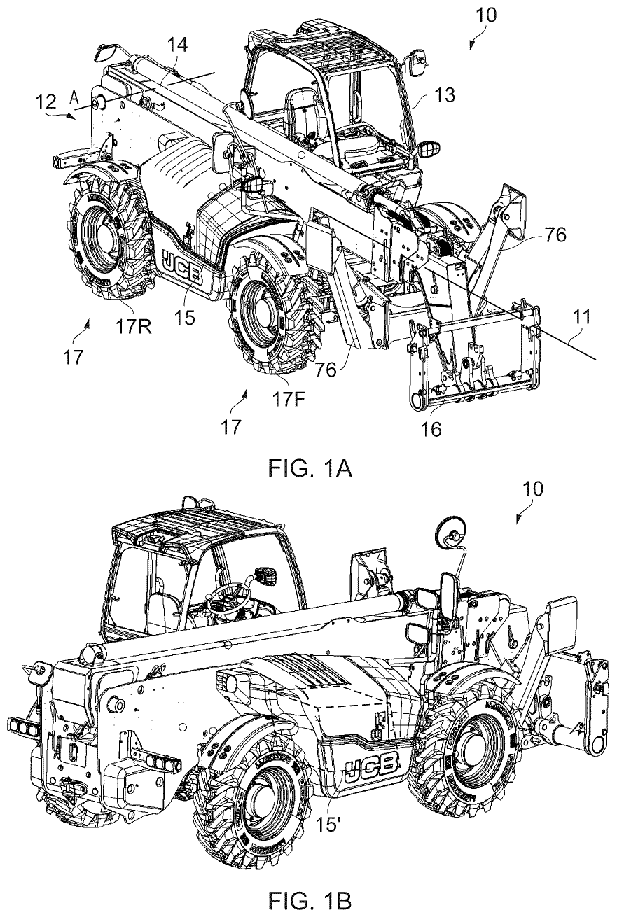

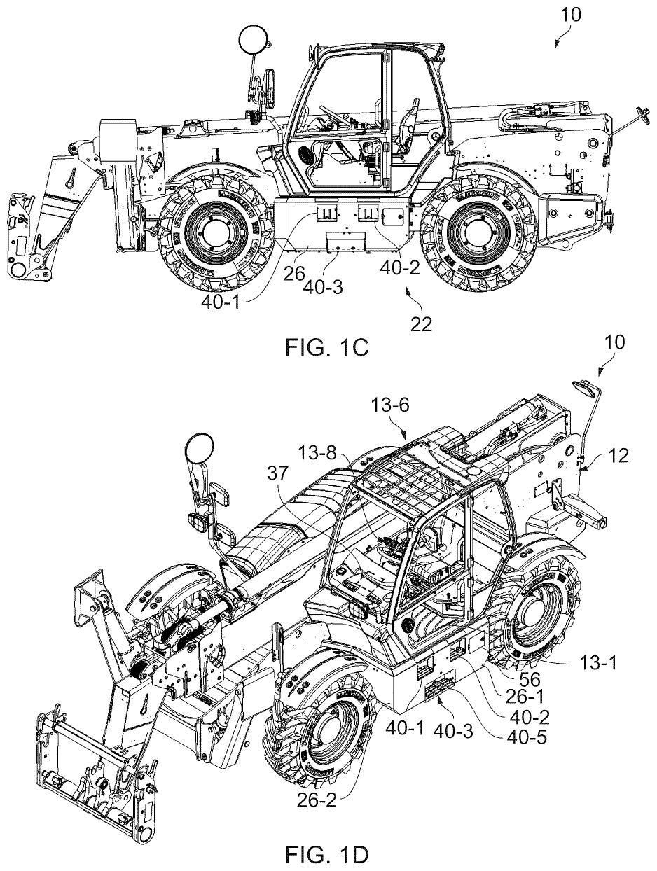

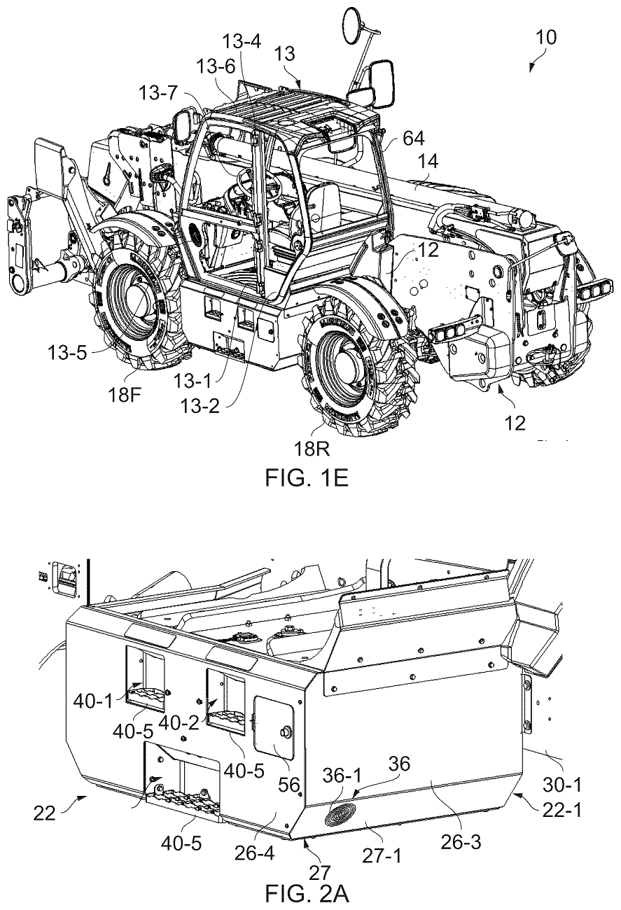

With reference to FIGS. 1a to 1e there is shown a working machine 10. The working machine 10 of the described embodiment is a material handling machine 10 in the form of a telehandler. However, it will be appreciated that the present disclosure may be applicable to other working machine which comprises a prime mover which is operable using a gaseous fuel.

The material handling machine 10 comprises a body 12, an operator cab 13, a lifting arm 14 pivotably mounted at a first end to the body 12 for pivoting movement about a first generally horizontal axis A, and an engine housing 15, in which a prime mover 15′ (shown schematically in FIG. 1b only) is located. The body 12 is located on a ground engaging structure 17 which is in the form of axle mounted front 17-1 and rear wheels 17-2. The machine 10 is generally elongate having a principal longitudinal axis 11. The operator cab 13 is aligned with the longitudinal axis 11 and defines the principal forward facing direction of travel of the working machine 10.

The lifting arm 14 is configured to carry a load handling implement (not shown) at a second end and may comprise a tool carrier 16 which is configured to attach a working implement to the machine 10. The tool carrier 16 is configured to pivot relative to the lifting arm 14 about a second generally horizontal axis so that a load may be kept in a constant horizontal or other desired orientation as the lifting arm 14 pivots up and down, as well known in the art.

The material handling machine 10 may comprise a prime mover 15′in the form of a gas engine which is configured to run on a gaseous fuel. The prime mover may be configured to provide motive power to the ground engaging structure and/or at least one hydraulic pump. The hydraulic pump may be used to drive hydraulic actuators required for the operation of the lifting arm or some other hydraulic service.

The gaseous fuel may be any suitable fuel such as compressed natural gas, hydrogen, landfill gas or biomass, for example, all of which are known in the art. The gas engine may be an internal combustion engine. In preferred embodiments, the engine will be either a port fuel injected or direct injected hydrogen internal combustion engine, as known in the art. In other embodiments, the power train of the working vehicle may comprise a hydrogen fuel cell or some other form of gas powered energy conversion device. The prime mover may be dual fuel in some embodiments, and the machine 10 may be a hybrid machine providing motive power from electrical and gaseous fuel energy sources. The gas engine may be powered exclusively by hydrogen.

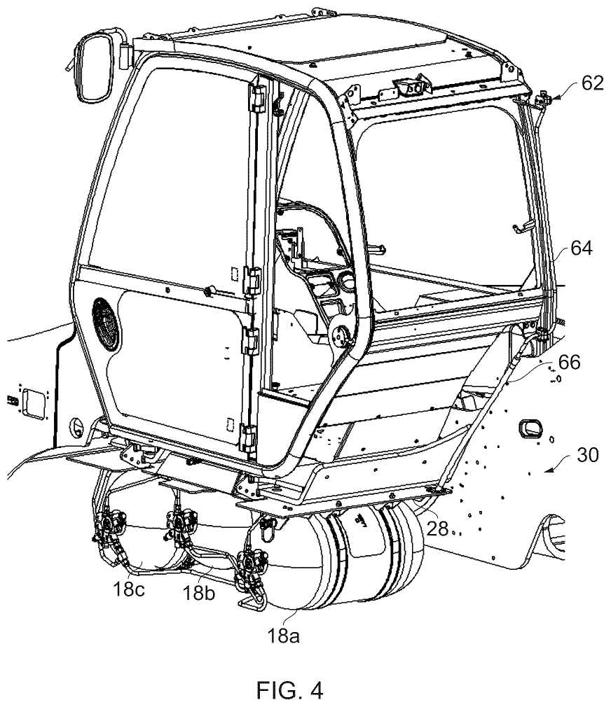

As best seen in FIG. 4, the material handling machine 10 may comprise one or more storage tanks 18a-c in which the gaseous fuel may be received and stored for use by the gas engine. The location of the storage tanks 18a-c may be anywhere suitable in the machine 10 but, preferably, the storage tanks 18a-c are provided under the operator cab 13. There are three storage tanks 18a-c shown in FIG. 4, but there may be more or fewer than this in other embodiments.

The storage tanks 18a-c are each generally torpedo shaped having a cylindrical central body with first and second hemispherical ends. The storage tanks 18a-c are elongate having a longitudinal axis 20 lying horizontal and transverse to the longitudinal axis 11 of the machine 10 and operator cab 13. In other words, the tanks 18a-c lie width-wise across the machine 10 and perpendicular to the length of the machine 10.

The storage tanks 18a-c are provided in a housing 22 (which may be referred to as an enclosure) beneath the operator cab 13. The housing 22 may comprise a bulkhead 24 and at least one external sidewall 26 which extends downwardly from the bulkhead 24. The bulkhead 24 may be configured to carry the weight of the storage tanks 18a-c and provide a sealed enclosure in combination with the sidewall(s) 26 such that escaped gaseous fuel may be vented to air at a safe location. As such, the bulkhead 24 is connected to the sidewall(s) 26 to provide a substantially sealed space save for one or more vents. In some embodiments, the bulkhead maybe provided integrally as part of the cab 13. Hence, the floor pan of the cab 13 may form part of a housing of the storage tanks 18a-c.

The connection between the sidewall(s) 26 and bulkhead 24 may be any suitable connection that provides a suitable seal. Thus, the bulkhead 24 and a portion of the side wall(s) 26 may comprise a single component formed or joined to prevent the escape of gas therebetween. Hence, the bulkhead 24 may be joined via welding or bolted with an intermediate seal member.

In the embodiment shown in FIG. 4, a seal member 28 is provided between the two such that the bulkhead 24 and sidewalls 26 may be separately installed. The seal member 28 may be a resiliently deformable compressible or flexible seal member 38 provided around a peripheral edge of the bulkhead 24 and positioned such that it is compressed by the sidewall(s) 26 as when the two are assembled together. It will be appreciated that the use of a resiliently deformable compressible or flexible seal member 28 between the bulkhead 24 and the sidewall(s) 26 may be advantageous for ease of assembly and to allow differential movement between the two components in service. As such, the bulkhead 24 and tanks 18a-18c and associated pipework may be provided as a sub-assembly and installed prior to the housing side wall(s) 26 being installed.

In the described embodiment, the seal member 28 comprises a bubble seal which are well known in the art, however, other forms of compressible or flexible strip seals or members will also be possible. It will be appreciated that the specific geometry and material of the seal member will be application specific as known in the art and not described further here.

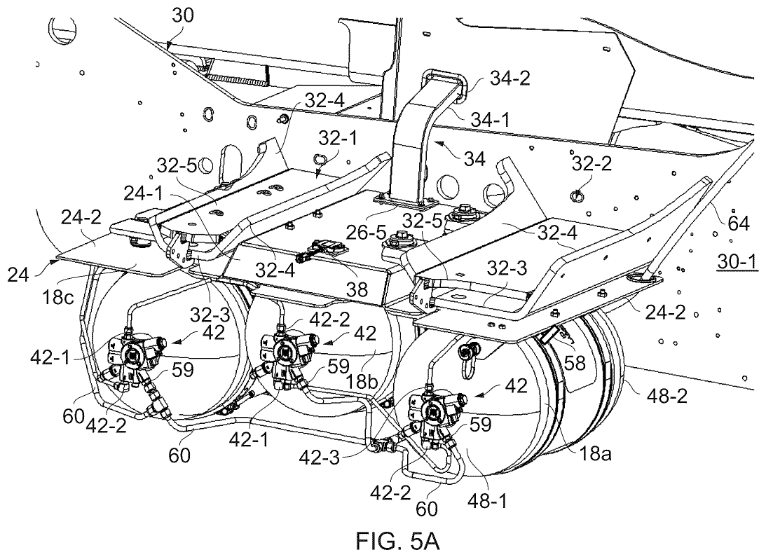

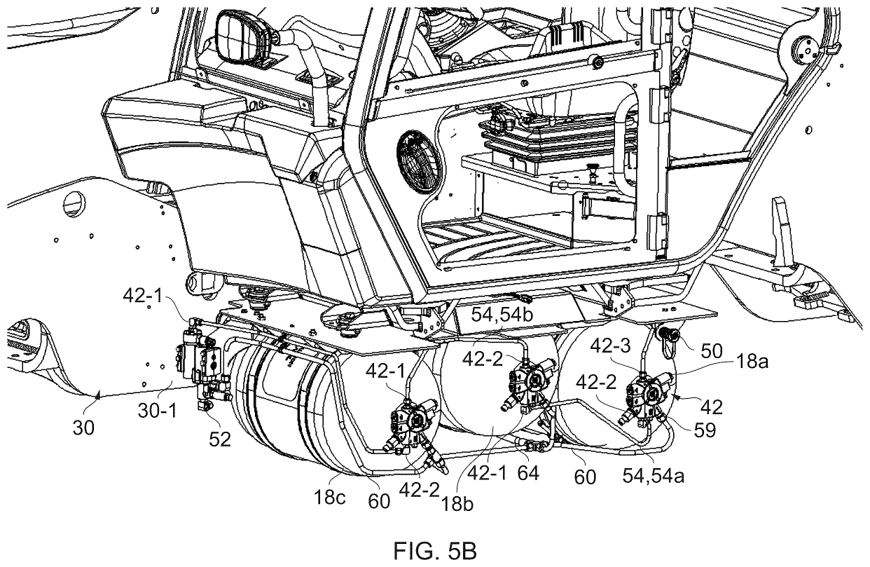

The bulkhead 24 may comprise a plate-like member having one or more elevated portions 24-1 to provide a gas funnel for guiding escaped gas towards an opening thereby allowing it to vent to air at a chosen safe location. The elevated portion 24-1 of the embodiment may be seen in FIG. 5a and includes a single elevation at a central portion of the bulkhead 24. Hence, there is provide a bulkhead 24 having a central elevated portion 24-1 provided at a first height with adjacent side regions 24-2 provided at a second, lower height. The elevated portion 24-1 may extend longitudinally along the central axis of the central storage tank 18b and transversely across the tank width. The elevated portion 24-1 may extend along the full length of the tank and across the central third of the width of the storage tanks 18a-c when viewed side on, as shown. Hence, the elevated portion 24-1 extends in a common direction with the storage tanks and may have a size and geometry suitable for receiving a portion of one of the storage tanks 18a-c. As described further below, the elevated portion 24-1 may be received between cantilever members (which may be referred to as arms) 32-1 and 32-2 which support the cab 13.

In the described embodiment, the plurality of storage tanks 18a-c are provided in a laterally distributed array so as to be located side-by-side and extending in a common transverse direction relative to the length of the machine 10. One of the storage tanks, the central storage tank 18b in the described embodiment, is elevated with respect to the other tanks 18a,c such that its center line is placed vertically higher. This allows the side tanks 18a,c to be moved laterally inwards whilst maintaining a suitable mutual separation between the tanks 18a-c. As such, the tanks 18a-c can be occupying a smaller footprint for a given size of tank 18a-c, thereby maximizing the storage beneath the cab 13 whilst maintaining ground clearance. In other embodiments, the storage tanks may be longitudinally aligned along the fore-aft direction. An advantage of a longitudinal alignment with the direction of travel is that it reduces the stress on circumferential retention straps during acceleration and braking of the vehicle.

In the working machine 10, the storage tanks 18a-c are advantageously located fully beneath a floor plate 13-1 of the operator cab 13 and between the front 17-1 and rear 17-2 wheels. As such, the storage tanks 18a-18c are provided with a degree of overhead and side-impact protection.

As can be seen, the central tank 18b is partially located within elevated portion 24-1 thereby allowing the width of the tank assembly to be reduced. Hence, the provision of an elevated portion 24-1 in a central region is advantageous not only for guiding escaped gas to the vent, but also for receiving a portion of one of the central tank 18b and allowing a more compact tank assembly.

In addition to providing the above advantages, the bulkhead 24 may be used to provide a structural member from which the storage tanks 18a-c are suspended. In doing so, there may be provided a storage tank assembly comprising the storage tanks 18a-c and the associated valves and/or pipework and the bulkhead 24. The storage tank assembly may form a sub-assembly which is mounted to the chassis 30 as a single unit. An advantage of providing a storage tank assembly is that it allows the storage tanks 18a-c and associated pipework and valves/regulators to be assembled and tested prior to being installed in the working machine. This may provide convenience in assembling and testing and may also prevent excessive re-work where a fault is later detected. In an embodiment, the storage tank assembly comprises a supporting member, e.g., the bulkhead, to which a plurality of tanks are mounted, the tank valves associated with each of the tanks, an outlet regulator and a filling inlet nozzle. The storage tank assembly may additionally comprise the external housing.

In the example shown, the bulkhead 24 is attached to the chassis 30 via a cab support structure 32. The cab support structure 32 is configured to provide structural support for the operator cab 13 and may take any suitable form. In the described embodiment the cab support structure 32 comprises a pair of cantilever members 32-1, 32-2 which extend from a chassis side wall 30-1. The chassis side wall 30-1 may a sidewall of the lifting arm housing, as described further below.

The use of cantilever members 32-1, 32-2 is particularly advantageous as it allows the elevated portion 24-1 to be located therebetween. Hence, it is possible to utilize the space under the cab floor plate 13-1 to accommodate a part of tank 18b which resides within the elevated portion 24-1, which in turn allows the tanks 18a-c to be more closely grouped together.

The elongate cantilever members 32-1,-2 extend from a first end fixed to the chassis side wall 30-1 to a terminal free end. The cantilever members 32-1,-2 together provide a platform on which the operator cab 13 sits on and is attached to. The attachment between the operator cab 13 and the cab support structure 32 may be of any suitable type. In the present embodiment, the operator cab 13 may be mounted by a plurality of flexible mounting pads, for example, four, which allow relative movement of the cab in service, thereby improving the operator ride quality and experience. However, the use of such pads may be omitted.

The cantilever members 32-1,-2 of the present embodiment comprise an open topped box beam having a c-beam profiled in which there is provided a base 32-3 having two side walls 32-4 extending upwardly therefrom. The cantilever members 32-1,-2 may comprise splayed side walls 32-4 which are inclined outwardly from a centerline of the base 32-3 to provide a flat bottomed V-shaped profile. The inclination of the sidewalls 32-4 may be between 35 degrees and 75 degrees and advantageously allow the depth of the cab support structure 32 to be reduced when compared to a convention c-beam section with vertical side walls. Hence, the space below the cab support structure 32 can be maximized, thereby allowing for larger storage tanks and/or storage tanks which are suspended higher above the ground plane of the ground engaging structure 17. In some embodiments, the use of the inclined side walls 32-4 allows the ground clearance of the machine to be in line with conventional machines of the same kind, whilst allowing of larger storage tanks.

As can be seen, the base 32-3 of the cantilever members 32 may comprise a gusset piece 32-5 which extends between the side walls 32-4 along the length thereof to provide a platform for mounting the operator cab 13, and a cavity below in which the fixings for the cab mounts and bulkhead 24 can be received. The use of a gusset piece is optional and may be provided to aid the mounted of the operator cab.

In some embodiments, the cantilevers may be provided in the form of box sections rather than c-beams. The box sections may be conventional with four walls set at 90 degrees to each other, or may be trapezoidal with the side walls inclined outwards as described above.

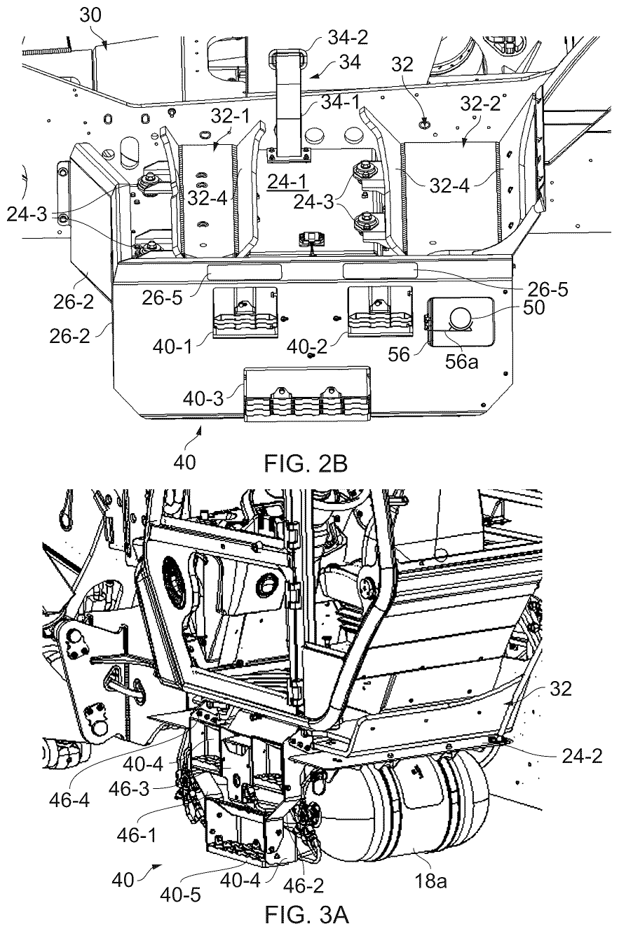

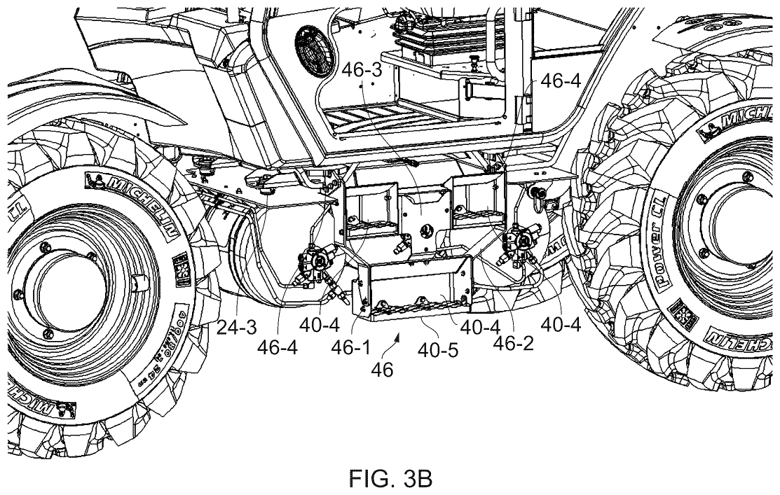

As noted, as well as providing the structural support for the operator cab 13, the cab support structure 32 may provide a structural member from which the bulkhead 24 may be suspended. As best seen in FIGS. 2a, 2b and 5, the bulkhead 24 is attached to the cab support structure 32 via a plurality of attachment points distributed across the upper surface thereof. The specific number and location of the attachment points may vary according to the embodiment, but in the example shown in FIG. 3b, the cab support structure 32 is provided with a plurality of small cantilever brackets extending from an underside thereof to provide the attachment points. The attachments may be achieved using conventional threaded studs and nuts (or bolts) but other means will be possible.

In order to help protect and/or decouple the gas storage system from unnecessary vibration generated by the machine 10 in service, the bulkhead 24 may be attached via suitable antivibration mounts 24-3. Anti-vibration mounts are generally known in the art and act to mechanically decouple the bulkhead 24 and storage tanks 18a-c from the main chassis so as to avoid unnecessary vibration and mechanical shock.

The bulkhead 24 is provided with four attachments in the example shown with two on the lower side regions 24-2 and two on the elevated portion 24-1. However, more or fewer attachments may be used in some embodiments and the location may vary.

As noted above, the bulkhead 24 may be suspended from the cab support structure 32 and comprise a seal in order to allow relative movement between it and the sidewall(s) of the housing 22. As shown in FIG. 2a, the housing sidewall 26 comprises an outer housing 26-1 and the chassis sidewall 30-1. The outer housing 26-1 may comprise, with respect to the machine orientation, a front wall 26-2, a rear wall 26-3 and an external cab side wall 26-4 and the base walls 27 and 27-1. The front wall 22-2, rear wall 22-3 and base wall 27 may be attached to the chassis side wall 30 at a plurality of fixing points using conventional means such as a threaded stud or nut and bolt. In some embodiments, the housing 22 may extend below the chassis side wall 30-1 in which case there may be an additional in-board side wall (not shown) which extends upwards from the base wall 27 to the chassis side wall 30-1. In some embodiments, the in-board side wall may be used to locate one or more air inlets or blower units 36 which are described further below.

The interface between the outer housing 26-1 and the chassis side wall 30-1 may be provided with a suitable seal so as to aid the correct venting of any escaped gaseous fuel.

The bulkhead 24 may comprise a single continuous sheet of material, e.g., steel, or may be fabricated from a plurality of pieces which are suitably joined together to provide the necessary seal. The outer housing 26-1 may comprise sheet material which is folder and/or joined to provide the enclosure. The outer housing 26-1 is substantially sealed with the exception that the external cab side wall 26-4 may comprise a plurality of apertures to provide access to cab access steps 40, which are described in further detail below, and an inlet 36-1 for the purge air.

As best seen in FIGS. 2b and 5, the elevated potion 24-1 of the bulkhead 24 may include a vent 34 for allowing gaseous fuel to be vented to air at a safe location. The vent 34 is pictured as being located towards an inboard side of the bulkhead elevated portion 24-1 and includes a vent line 34-1 which extends from a vent aperture in the bulkhead 24 and extends upwards and towards and through the chassis side wall 30-1. In other embodiments, the vent line 34-1 may be directed forwards or rearwards of the operator cab 13 to a suitable outlet. The chassis side wall 30-1 of the described embodiment defines a lifting arm housing in which the lifting arm 14 resides when in a non-working position or lowered and/or which provides the pivoting mount defined by axis A for the lifting arm 14. The lifting arm housing may comprise a pair of parallel sidewalls and may be dimensioned to comfortably receive the lifting arm 14 with sufficient clearance to allow any vented gas, e.g., hydrogen, which is significantly less dense than air, to rise upwards rapidly and diluted to avoid accidental ignition. Further, the lifting arm housing may be devoid of any electrical equipment which may provide a source of ignition.

A further advantage of venting the bulkhead 24 into the lifting arm housing is that it is at an inboard, generally central location of the machine 10 so aids separation from potential ignition sources on the exterior of the machine 10. Further, the outlet 34-2 is also on an inboard side of the operator cab 13 which may help to obscure the vent 34-2 from sight and further separate escaped gas from any sources of ignition which may be in the operator cab 13. Further, the lifting arm 14 may help shield the vent outlet from water ingress from above.

The vent 34 may be passive in that it merely provides fluid communication between the interior of the storage tank housing 22 and the exterior of the machine 10 such that gaseous fuel which has a significantly lower density than air, can passively rise out of the vent 34 to exit externally to air. Hence, the vent 34 may be provided in the highest location of the housing 22 with the pipe outlet 34-2 being located higher than the inlet and providing a continually upward trajectory.

The location of the vent 34 in the bulkhead 24, the cross-sectional area of the pipe 34-1 and the outlet 34-2 may vary in different embodiments. In the embodiment shown, the vent 34 is, as noted, positioned towards the chassis sidewall 30-1 which defines the lifting arm housing. The cross-section of the pipe 34-1 is rectangular, thereby increasing the cross-sectional flow area (compared to a circular pipe of a comparable diameter although round or circular may be used in other embodiments). The above advantages notwithstanding, in some embodiments, the vent outlet 34-2 may advantageously be provided elsewhere such as fore or aft of the operator cab 13 or within the step pockets where suitable.

Although the vent 34 is passive and does not include any air shifting components, in some embodiments, it may be desirable to provide forced ventilation to help purge the housing 22 of any escaped gaseous fuel. As such, the housing 22 may comprise a blower unit 36 (an example being shown in the embodiment of FIG. 2a), such as an electric fan, which is configured to provide positive pressure in the housing 22 so as to create a purge flow via the vent 34. In some embodiments, the blower unit 36 may be configured to suck air into the housing 22. In such instances, the blower unit 36 may be an intrinsically safe electric fan which cannot result in a spark with sufficient energy to ignite any escaped gas. Such a fan may comprise a brushless fan motor, for example.

The blowing unit 36 may be provided in any suitable location. Generally, it will be preferable to provide the blowing unit on an opposite side of the housing relative to the vent 34 to provide a more effective purge flow through the housing 22. Further, if the vent 34 is located in an uppermost surface, providing the blowing unit 36, which may provide a potential source of ignition, at an opposite end of the housing 22 provides some natural separation.

The housing 22 may comprise a base wall 27 on the underside of the storage tanks 18a-c to provide some protection against the ingress of foreign matter into the housing 22 and gas storage system, for example. The base wall 27 may comprise an aperture which provides an inlet for a flow of purge air with the blower unit 36 located internally or externally.

As best seen in FIG. 2a, a rear lowermost corner 22-1 of the housing 22 may be provided with an inclined wall portion 27-1 which extends between lowermost portion of the base wall 27 and the side wall 26.

The blower unit 36 may be a conventional intrinsically safe electric fan unit having a rotating impeller driven by an electric motor to provide a suitable airflow, as known in the art. It will be appreciated that the size and flow rate of the blower unit 36 will be application specific and may vary amongst embodiments.

The blower unit 36 may be configured to provide only a positive airflow into the housing 22 such that air and any associated gas which has accumulated within the housing 22 is forced upwards and out of the vent 34, rather than across the blower unit 36. In doing so, the flow of gas across the fan and any potential contact with an associated source of ignition may be minimized.

The blower unit 36 may be on permanently when the machine 10 is powered up and/or the engine running, scheduled to run at predetermined times or operating conditions, or may be activated in the event of gas build-up beyond an acceptable level. As such, the machine 10 may comprise a controller 37 (seen in FIG. 1d) which is communicably connected to the blower unit 36 and configured to control the operation of the blower unit 36.

In the case of a gas build-up, the housing 22 may be provided with a gas sensor 38 which can detect an amount or concentration of gas within the housing 22. The gas sensor 38 may be communicably coupled to the controller 37 and may provide an input signal to the controller 37 which is indicative of the gas build up within the housing 22.

The decision to activate the blower unit 38 and evacuate the housing 22 may be achieved with the use of one or more predetermined thresholds. Thus, the controller 37 may be configured to receive an input signal from the sensor 38 which is indicative of the gas concentration within the tank housing 22, compare the input signal with a predetermined threshold and activate the blower unit 38 if the signal is above the threshold. The blower unit 38 may then be powered up until the gas concentration drops down below the first or a further threshold, or may be powered on for a predetermined amount of time.

In some instances, the controller 37 may be configured to provide an operator with a warning when gas is sensed within the housing 22. Hence, the operator cab 13 may be provided with one or more warning device, such as a visual, audio or haptic output device, configured to provide an operator with a suitable indication or warning in the event of detected gas leak. The visual, audio and/or haptic output device may be any suitable device known in the art and may comprise one or more of an illuminated display device, speaker, sounder, vibration device, for example. The illuminated display device may comprise one or more LEDs, and/or a display screen configured to provide one or more of an image, text or warning light. In some embodiments, the output of the sensor 38 and/or the warning device may be remotely monitored to via a suitable communication link. The remote monitoring may be carried out for maintenance or performance reasons, for example.

The controller 37 may be configured to provide the operator warning and/or activate the fan at one more threshold levels. Hence, there may be first threshold at which the operator is provided with a warning, a second threshold at which the fan is activated, and a third threshold at which the engine is shut down and/or the tanks are isolated via the tank valves. It will be appreciated that one or more of the thresholds may trigger multiple events. For example, a first threshold may result in the operator being provided with a warning and the fan starting, and a second threshold may result in the tanks being isolated or purposes evacuated in a controlled manner, the engine shut down or the operator being provided with an alternative warning.

The one or more thresholds described above may be determined in line with acceptable levels of gas concentration. In some embodiments, the thresholds may be associated with, for example, a 1% concentration of gas which may be indicative that there is a definitive leak or that may be harmful for an operator by causing dizziness or impairing cognitive functions. In other embodiments, one or more thresholds may be associated with a 2.3%-2.9% threshold, which corresponds to a potentially dangerous rise in gas build up which is approaching a combustible concentration which is 4% for hydrogen. Other ranges and valves of threshold are possible.

The controller 37 may be a conventional controller 37 as known in the art and may comprise one or more conventional electronic control units, ECU, which are used to operate the machine 10. The ECU may comprise one or more of an engine management ECU, display ECU, general machine ECU or a dedicated gas control ECU. As will be appreciated, the controller 37 may comprise one or more processors and a computer-readable storage medium comprising instructions which, when executed by the processor, cause the processor to carry out control method described herein.

As can best be seen in FIG. 1d, access to the operator cab 13 is may be provided by an opening in a cab side wall 13-2. In the embodiment shown, there is shown a door 13-3 pivotable about a plurality of hinges 13-4 provided on an aft cab pillar thereof and a handle 13-5 provided towards the front for latching and optionally locking the door 13-3 in a closed position. It will appreciated that the presence and arrangement of the door 13-3 may differ variously in embodiments of the present disclosure.

Immediately and directly below the cab entrance there is provided a plurality of cab access steps 40 which are configured to receive an operator's feet when entering or exiting the cab 13. In prior art machines, the steps 40 typically comprise a vertically inline array including two or three treads depending on the size of the machine or a single step. The steps are typically provided flush with the external wall of the cab 13 and extend thereunder. An issue with this type of prior art step arrangement for a machine having storage tanks below the cab 13, is that the steps necessarily reduce the volume in which the storage tanks 18a-c could be stored.

To negate this, the present disclosure provides a material handling machine 10 comprising: a body 12 mounted on a ground engaging structure 17; a telescopic lifting arm 14 pivotally mounted to the body 12; an operator cab 13 mounted to the body 12 adjacent the telescopic arm 14; and a plurality of steps 40 located beneath an entrance to the operator cab 13 to facilitate access; and, a plurality of storage tanks 18a-c for receiving a gaseous fuel, wherein the storage tanks 18a-c are located beneath the operator cab 13 and laterally distributed so as to sit side-by-side beneath the floor of the operator cab 13 behind the plurality of steps 18a-c.

The steps 40 may be positioned around one or more of the storage tanks 18a-c so that a portion of one of the storage tanks 18a-c, such as an end portion and/or a tank valve 42 and/or associated pipework is located between two of the steps 40, either horizontally or vertically when viewed along the length of the tanks 18a-c. The portion of the tanks 18a-c may project between two of the storage tanks 18a-c so as to extend axially beyond the rear-most portion of the steps 40. In other words, a portion of one or more of the tanks 18a-c may project beyond a vertical plane defined by a rear-most face of a step tread plate 40-5 or a rear wall of a step pocket 40-4. In some embodiments, the separation of the steps 40 may simply provide a required separation between the housing/steps and the portion of the tanks 18a-c and the portion of the tanks may not extend forward of the rear plane of the steps 40. The steps 40 may radially overlap two or more of the tanks 18a-c when viewed head on.

Arranging the steps 40 about the tanks 18a-c so that the steps 40 extend axially between the tanks 18a-c (and vice versa) allows the storage area for the tanks 18a-c under the operator cab 13 to be maximized.

In order to maximize the size of the storage tanks 18a-c, the present disclosure provides laterally separated steps 40-1, 40-2 at a common height. Thus, an upper step (which could be a lower step in some embodiments) may comprise a plurality of individual steps 40-1, 40-2 with a portion of a tank 18b located therebetween. In some embodiments, a portion of one of the tanks 18a-c may be additionally or alternatively located between steps provided at different heights. Thus, as described further below, a tank valve 42 or other portion of a tank may be located above a lower step 40-3 and between upper steps 40-1, 40-2.

Further, as previously described, the storage tanks 18a-c, and/or tank valves 42, may be provided at different heights such that a central tank valve 42-b is located above a lower step 40-3 and between two upper steps 40-1,40-2, and the upper steps 40-1, 40-2 are located above one or more side tank valves 40-a, 40-b. In the embodiment shown, the relative heights of the tank valves 42 when viewed left to right are low, high, low, and the relative heights of the steps 40 are high, low, high, thereby allowing the steps 40 and tanks 18a-c provided at a common lateral position be vertically separated allowing them to axially overlap.

More specifically and with reference to FIGS. 3a and 3b, there is provided step pockets 40-4 in the external cab side wall 26-3 of the housing 22. The pockets 40-4 may comprise a closed walled structure which maintains the sealed integrity of the housing 22 with each pocket including a tread plate 40-5 for receiving an operator's foot. Each pocket 40-4 may comprise side walls located on either side of the treadplate 40-5, a base wall below the tread plate 40-5, an inboard rear wall and an upper wall. However, it will be appreciated that one or more of the pocket walls may be omitted when not needed for the integrity of the housing 22. This can be seen in the lower step 40-3 which includes the rear wall, side walls and upper wall, but no base wall which has been omitted so that the lower edge of the pocket 40-4 is defined only by the tread plate 40-5. In the other pockets, the tread plate 40-5 may be spaced above the base wall to allow debris and fluid to drain. As can be seen, the upper steps 40-1, 40-2 and lower step 40-3 are each formed by distinct pockets 40-4 with a portion of the outer wall extending therebetween. The lateral separation and inboard extension of the pockets 40-4 creates internal recesses therebetween in which a portion of the tanks 40 can be received.

The upper steps 40-1, 40-2 may be equidistantly separated on either side of the center axis 44 of the central tank 18b. Each upper step 40-1, 40-2 may have a width which is less than the separation between the center tank 18b and an adjacent tank 18a or 18c such that the pockets 40-4 of the upper step 40-1, 40-2 may be received between the respective tank valves 42.

The lower step 40-3 may be provided as a single step which may be centrally arranged between the two upper steps 40-1, 40-2. The lower step 40-3 is centered between the upper steps 40-1, 40-2 and extends laterally beyond the respective inner edges thereof such that a portion of the steps 40-1, 40-3 and 40-2, 40-3, approximately one quarter to one third, overlap in vertical alignment when viewed from the cab side of the machine 10. The width of the lower step 40-3 is less than the separation between the tank valves 42 on the two side tanks 18a, 18b such that it can be accommodated therebetween.

The dimensions of the upper step pockets 40-1, 40-2 may comprise a height of between 150 mm and 225 mm, optionally between 160 mm and 190 mm, a depth of between 100 mm and 200 mm, optionally 140 mm to 150 mm and a width of between 150 mm and 300 mm, optionally between 150 mm and 250 mm. The dimensions of the lower step 40-3 may comprise a height of between 150 mm and 225 mm, optionally between 160 mm and 190 mm, a depth of between 100 mm and 200 mm, optionally 140 mm to 150 mm and a width of between 300 mm and 500 mm, optionally between 400 mm and 450 mm. It will be appreciated that other sizes are possible.

It will be appreciated that the exact arrangement of the upper steps 40-1, 40-2 and lower step 40-3 will be dependent on the size, spacing and shape of the tanks 18a-c and may differ from the example shown here. In some embodiments, for example, both the upper and lower steps, or lower step only, may comprise laterally separated pockets. Hence, there may be a single upper step and a plurality of lower steps provided at a common height. Further, there may be more than two levels of steps, each of which may comprise a single step or a plurality of laterally separated steps to accommodate the storage tanks and increase the available under cab storage area. In some embodiments, the upper and lower steps may be single steps horizontally offset with respect to each other such that they are not vertically aligned. In doing so, the upper and lower steps can be shifted laterally with respect to each other to accommodate the tank valves and/or tanks and/or gas lines as required. Providing two steps at a given height is particularly advantageous as it allows for ease of use with either foot.

As described above, one or more the storage tanks 18a-c may be positioned higher than one or more of the other tanks. In the embodiment shown, the higher position of the central tank 18b allows it to be located above the lower step 40-3 and flanked by the upper steps 40-1, 40-2 which in turn sit above the height of the lower side tanks meaning a single lower step 40-3 and two upper steps 40-1, 40-2 is particularly advantageous. The center height of the side tanks 18a, 18c may be below the upper steps 40-1, 40-2 allowing the upper steps to be placed further out and/or be wider. Hence, in some embodiments (not shown), the upper steps 40-1, 40-2 may extend over the tank valves 42 or other portion of the side tanks 18a, 18c and reside on either side of and level with a tank valve 42 or portion of the central step 18b.

In addition to providing advantageous packaging, a single lower step 40-3 and two upper steps 40-1, 40-2 works well as it allows a user to place either foot on the lower step 40-3 whilst being able to naturally place the other foot, be it the left or right, in one of the right or left step pockets 40-1, 40-2 without having to shift body positions. That is, the arrangement of the steps 40 lends itself equally to people with a dominant left foot or a dominant right foot.

The steps 40 may be formed as an integral part of the outer housing 26-1 or may be separately attached to the chassis 30 and/or bulkhead 24 to provide additionally rigidity. Separately attaching the steps 40 to the chassis 30 and/or bulkhead 24 may reduce the strength required from the housing 22, thereby saving weight and cost, and may also help to reduce movement in the steps 40 during use, thereby helping to preserve the sealed integrity of the housing 22.

In some embodiments, it may be preferable to construct the steps 40 as a sub-assembly prior to attaching them to the chassis 30 and/or bulkhead 24 and/or outer housing 26-1. Hence, as shown in FIGS. 3a and 3b, the steps 40 may be formed as a sub-assembly 46 comprising the individual step pockets 40-4 which are joined together with one or more structural members 46-1, 46-2, 46-3. The sub-assembly 46 may be attached to the chassis 30 or bulkhead 24 as required, prior to receiving the outer housing 26-1. Providing a sub-assembly of steps helps limit the amount of time and assembly work needed in and around the storage tanks on the machine and reduces risk of damage.

In the embodiment shown, the upper steps 40-1, 40-2 each include an external side wall and an internal side wall (relative to the sub-assembly), and the lower step 40-3 comprises two external side walls. The sub-assembly 46 comprises first 46-1 and second 46-2 lateral support members which extend between the respective external edges of the upper 40-1, 40-2 and lower steps 40-3 on either side of the arrangement. The upper end of the lateral support members 46-1, 46-2 each include an attachment point 46-4 which is attached to the cab support structure 32 which provides the necessary structural rigidity for supporting the steps 40 in use. More specifically with reference to FIGS. 3b and 4, each of the cab support cantilevers 32-1, 32-2 is provided with an attachment plate which projects outwardly towards the external cab side of the machine 10. Each lateral support member 46-1, 46-2 comprises a corresponding plate such that the two can abut and be fixed together, for example, using a plurality of bolts (as shown).

The lateral support members 46-1, 46-2 may take any suitable form which provides the necessary support. In the described embodiment the lateral support members 46-1, 46-2 comprise flat plates which attach to the vertical external side walls of the step pockets 40-4 using one or more conventional means, such as a nut and bolt fixing. The plates may be provided with a lateral offset in the form of a dogleg which accounts for the difference in the vertical alignment of the external edges of the upper 40-1, 40-2 and lower 40-3 steps.

The internal walls of the upper 40-1, 40-2 and lower 40-3 steps are joined by a central member 46-3. The central member 46-3 attaches the opposing internal pocket side walls of the upper steps 40-1, 40-2 and the upper pocket wall of the lower step 40-3. The central member 46-3 may be floating in that it may not be directly attached to the chassis 30 or cab support structure 32. As can be seen, the central member 46-3 may be take the form of a T or Y piece with each terminal end being connected to a step pocket wall.

The central member 46-3 may comprise one or more apertures or cut-outs to allow inspection and access of the tank valves 42 and pipework associated with the storage tanks 18a-c. However, it will be appreciated that the sub-assembly 46 lends itself to being removed for maintenance purposes due to the attachment points 46-4 provided at the free end of the cab support structure 32.

In order to expose the step pockets 44, the external cab side wall of the housing 22 comprises apertures which correspond to the dimensions of the step pockets 44. It will be appreciated that the interface between the outer housing 26-1 and the step pockets 44 may be provided with a seal member (not shown) to maintain the integrity of the housing 22. Further, a seal member may be provided between the bulkhead 24 and a rear side of the upper step pockets if required.

It will be appreciated that in some embodiments, the step pockets may be formed as an integral part of the side wall of the housing rather than being a separately mounted sub-assembly.

As can be seen from FIGS. 1e and 2a the housing 22 may extend above the bulkhead 24 to meet the underside of the cab floor plate 13-1 and/or door 13-3. In doing so, the upper portions of the outer housing 26-1 may obscure the cab support structure 32 and encloses a void which extends between an upper surface of the bulkhead 24 and underside of the floor plate 13-1.

In the unlikely event that escaped gas will be able to collect in this void, the upper portions of the sidewall(s) 26 may comprise one or more vent openings 26-5. In various embodiments, the vent openings 26-5 may be provided in the upper portions of the outer housing 26-1, or in the chassis side wall 30-1.

In the embodiment shown in FIG. 2b, the vents 26-5 are provided on an inclined upper edge of the outer housing 26-1 immediately and directly above the upper first 40-1 and second 40-2 steps. As shown, the vents 26-5 may be aligned with the steps 40-1, 40-2, such that the edges of the steps and the edge of the vents are provided at a common lateral position on each side, however, this is not a limitation. The positioning of the vents 26-5 in this location may provide an indication of the step location to an operator exiting the operator cab 13. Without the vents 26-5, the location of the steps 40 would be obscured due to the vertical orientation of the housing wall which cannot be readily viewed from the cab 13. The use of vents 26-5 as indicators for the location of the steps 40 may provide a convenient way for locating the steps 40. In other embodiments, the steps may be indicated using grit strips, decals or paint etc, which may be preferable for preventing water ingress.

The plurality of storage tanks 18a-c of the present disclosure may be arranged in an array. The array may comprise a lateral distribution of the storage tanks 18a-c so that they reside side-by-side beneath the cab 13. As will be appreciated, the storage tanks 18a-c will require one or more gas lines 54 for filling and discharging the gaseous fuel. Further, the gas storage arrangement requires one or more valves 42 to control the flow of gas into and out of the tanks 18a-c. The gas lines 54 may be referred to as conduits or pipework and may generally comprise an external cylindrical wall which defines a passageway to provide fluid communication for pressurized gas between the various parts of the storage tanks 18a-c and other parts of the machine 10.

In some embodiments of the present disclosure, the each of the tanks 18a-c are provided with an on-tank valve 42. The on-tank valve 42, which may be referred to as a tank valve 42, may be fitted to the first end of the tanks 18a-c to inboard of the housing 22. As such, the present disclosure provides an off-highway machine comprising: a body 12 mounted on a ground engaging structure 17; an array of storage tanks 18a-c for receiving a gaseous fuel within the body 12, each storage tank 18a-c comprising a cylinder having a central axis 44, a first end 48-1 and a second end 48-2, and oriented such that first end of each storage tank 18a-c is provided on the same side of the array, wherein each first end 48-1 of the storage tanks 18a-c is provided with a tank valve 42 for controlling the flow of gaseous fuel into and out of the respective storage tank 18a-c.

Thus, there is provided an array of storage tanks 18a-c, each having corresponding tank valve 42 arranged adjacent one another, typically on an outboard end of the tanks to provide convenient access for maintenance and the like. Providing the tank valves 42 on an outboard side and adjacent to one another is advantageous for providing easier installation and maintenance and also for maximizing storage. However, mounting the tanks with the valves on an inboard may be preferable in other embodiments for providing improved impact protection.

The tank valves 42 of the respective storage tanks 18a-c may be connected in series flow communication such that a first of the plurality storage tanks 18a comprises an outlet 42-2 in flow communication with the inlet 42-1 of the tank valve 42 of the second tank 18b, and the second tank valve 42 may comprise an outlet 42-2 which is in flow communication with an inlet 42-1 of the tank valve 42 of the third tank 18c, and so one.

The first tank 18a in the series may be comprise a filling inlet valve 42-3 which is in flow communication with a filling nozzle inlet 50 such that the tanks 18a-c may be filled via the series connection. The final tank 18c in the flow series of tanks may be connected to an outlet regulator 52 or other point of use.

In order to provide the connection between the tanks 18a-c, each of the valves 42 may comprise a plurality of ports. The plurality of ports may include a first port and a second port, each providing an inlet 42-1 or an outlet 42-2 attached to a respective inlet conduit or an outlet conduit for receiving and delivering gaseous fuel to and from the storage tank 18a-c respectively.

The first and second ports may be configurable such they can act as an inlet port 42-1 for receiving a flow of gas from an upstream tank, or an outlet port 42-2 for discharging the flow of gas to a downstream tank. In the present disclosure, the first and second ports may comprise a bidirectional flow passage therebetween such that gas can flow in either direction. Hence, if the first port is connected to an outlet from an upstream tank it will be configured as an inlet 42-1, and the second port will act as an outlet 42-2 to deliver the gas to the downstream tank (or other end point).

A further advantage of providing a series connection of tanks in this way is that the common line pressure which connects all of the tanks facilitates the identification of faults in the individual tanks. That is, the pressure of the common line which series connects each of the tank valves can be measured, for example, at the outlet regulator 52, and this compared to each of the individual tank pressure measured, for example, by the tank valves. The discrepancy between the common line pressure and the individual tank pressure is too great, a sensor error can be inferred in a tank valve/sensor.

The physical location of the ports may be chosen in order to simplify the interconnection of the various gas lines 54. Hence, for example, each of the tank valves 42 may correspond to the other tank valves 42 of the plurality of tanks 18a-c so as to include a central body 42-4 which attaches to the respective tank and ports which extend radially therefrom, normal to the tank axis 44. The angular position of the first and second ports may be the same for each valve 42 so that, when mounted in a common orientation, the first ports all point upwards, and the second ports all point downwards, for example.

As the ports are configurable, e.g., bi-directional, it is possible for the interconnecting gas lines 54 to be provided on the same side of the tank valves. Hence, as can be best seen in FIGS. 5a and 5b, a first interconnecting gas line 54a which extends between the first tank 18a and the second tank 18b is provided on the bottom side of the first and second tank valves 42, and a second interconnecting gas line 54b which extends between the second and third tanks 18b, 18c may be provided on the upper side of the tank valves 42.

This arrangement in which the flow direction through the valves 42 interchanges between adjacent valves 42 allows the length of the interconnecting lines 54 to be reduced and the routing to be simplified. Thus, the space required for the gas storage assembly may be reduced and the size of the tanks increased.

In some embodiments, not shown, the first and second ports of adjacent tank valves 52 may face each other horizontally, thereby allowing the length of the interconnecting gas lines 54 to be further reduced, subject to the inclusion of any necessary slack to account of expansion or in-service movement.

As noted, the first tank 18a in the flow series is connected to a filling nozzle inlet 50. The filling nozzle inlet 50 may be provided proximate to the first tank 18a such that the length of the gas line 54 which extends between the two can be kept to a minimum. In the embodiment shown in FIGS. 5a and 5b, the filling nozzle inlet 50 is provided towards the top of the housing 22 so as to make the filling easier for the operator, and also to allow the filling nozzle inlet 50 to be firmly attached to the cab support structure 32 and/or bulkhead 24. As shown in FIG. 4, the outlet regulator 52 may be attached to the storage tank sub-assembly, e.g., to the bulkhead 24 via a suitable bracket and/or fixing, proximate the third tank 18c. The outlet regulator 52 may be sized and located so as to be behind the final tank 18c in a recess provided by the hemispherical end cap of the tank.

The filling nozzle inlet 52 may be configured to receive a corresponding nozzle of a refueling device (not shown) as is well known in the art. In order to protect the filling nozzle from the elements and general environment, the filling nozzle inlet 52 may be provided behind a door 56 provided in an external wall of the storage tank housing 22. The door 56 may be hinged as well known in the art.

The present disclosure also provides a nozzle support 56a configured to receive and support the weight of the nozzle during a filling operation. The nozzle support 56a may be provided on the inside of the door 56 such that, when the door 56 is opened to expose the filling nozzle inlet 52, the nozzle support 56a is deployed. The nozzle support 56a may take any suitable form and will be dependent on the refueling nozzle which is used. In some embodiments, the nozzle support 56a may comprise a shelf, saddle or collar which is cantilevered from the inside of the filling inlet nozzle door 56.

In order to simplify the assembly of the gas storage tanks 18a-c, it may be preferable to attach the tank valves 42 on to the individual tanks 18a-c prior to attaching the tanks on to the bulkhead plate 24 to provide the tank assembly for mounting to the machine. When doing this, each of the tank valves 42 and tanks 18a-c will need to be correctly orientated so that the ports are provided in the correct and corresponding locations. In order to achieve this, each tank 18a-c may be provided with an angular location feature such as a projection 58, seen in FIG. 5a, or a notched flange which can be receive or abut a corresponding feature on the bulkhead. Hence, for example, each of the tanks may be loosely coupled to the bulkhead 24 using band straps. The loose coupling is such that the tanks 18a-c can be rotated to allow the engagement of the angular rotation feature with the cradle in which it is located.

Each tank 18a-c may comprise a pressure relief valve 59, such as a thermal pressure relief valve which is configured to open when the internal temperature of the tank passes a pre-set temperature. Thermal pressure relief devices, TPRDs, are well known in the art. As shown, the pressure relief valve 59 may be provided within the tank valve 42 for convenience.

The pressure relief valves from each tank 18a-c may be connected to a tank vent line 60 which is extends to a tank vent outlet 62 which is located remotely from the storage tanks 18a-c. The connection between the plurality of tanks 18a-c and tank outlet 62 may be achieved using a radial configuration in which a vent line 60 extends from each tank valve 42 to one or more connecting nodes. A common vent line 64 extends from one of the connecting nodes to the outlet 62.

The arrangement shown in FIGS. 5a and 5b, there is provided vent lines 60 from the outlet regulator 52 and each of the tank valves 42. The vent lines 60 are connected by two separate nodes with the common vent line 64 extending from one of the nodes to the vent outlet 62 shown in FIG. 4. As with the first and second ports, the pressure relief valve 59 and associated port is provided in the same location on each of the tank valve 42 to simplify the connections and minimize the routing of the different lines.

The pressure relief valves 59 are configured to open in the event of an increased pressure, for example, as a result of increased temperature from a fire. Once triggered, the pressurized content of the storage tanks 18a-c is rapidly discharged down the vent lines 60,64 and out of the outlet 62. Further, it is likely that, if one pressure relief valves 59 opens then the other ones will open too (given they are subject to the same ambient conditions). Hence, the tank vent outlet 62 may be subject to a large discharge of gaseous flow in a short time window.

As such, the vent outlet 62 of the described embodiment may be provided above the body, optionally above the operator cab 13, optionally at the highest location on the machine 10 so that discharged gas can be vented to air unobstructed. The specific location of the outlet 62 will be application specific and may vary. The tank vent outlet 64 may be provided at an inboard portion of the machine and, in some embodiments, towards a central location. Providing the tank vent outlet 64 towards a central location of the machine 10 helps reduce the risk of ignition from ignition sources which are external to the machine 10. Where the working machine comprises a working arm, e.g., a lifting or excavating arm, the tank vent outlet 62 may be located inboard of the arm. The vent outlet 62 may be located within a central location of the machine 10. The central location may be on or adjacent to the longitudinal centerline of the machine 10. The central location may be within a region which is 30%, optionally, 25%, optionally 20% of the machine width from the longitudinal centerline. The central location may be between the first and second axle. The central location may be between the fore-aft extremities of the operator cab. The central location may be within a region which is 30%, optionally, 25%, optionally 20% of the machine length from the transverse centerline.

In some embodiments, where an operator cab 13 is centrally located, the tank vent outlet 62 may be provided on an inboard side of the cab 13. The tank vent conduit may extend up a front or rear support member of the operator cab, for example a corner pillar which supports the roof.

FIGS. 4 and 5b show an embodiment in which the vent line 60 from each of the tanks 18a-c join with the common vent line 64 at a node located between two of the storage tanks 18a,b. The common vent line 64 is extends inboard towards a rear lower corner of the operator cab 13 adjacent to the chassis inner wall. The common vent line 64 extends up the rear corner of the cab 13 to a top rear corner where the outlet 62 is located at or adjacent to the upper most surface of the cab roof 13-6.

The tank vent line 60 may extend from the plurality of storage tanks 18a-c to the body and/or operator cab 13 and comprises a portion of flexible conduit 66 to allow differential movement of the plurality of storage tanks in relation to the body and/or operator cab 13. The flexible conduit may extend from one or more of the valves 42 or nodes and may terminate to a rigid section of conduit. In the embodiment shown in FIG. 4, the flexible conduit 66 extends up a rear side of the cab 13 and transitions into a rigid conduit at or just below the rear window and within a protective cover 68 (see FIG. 1e) which forms part of the body 12. As such, the only conduit which is exposed is rigid, thereby providing a greater resilience to damage.

The conduits which go to make up the vent line 60, the common vent line 64, the flexible portions and rigid portions may be made from one or more of the group comprising: stainless steel, e.g., 316L, nylon, ptfe, polyamide, steel braid etc. In some embodiments, the flexible portions may comprise a laminated polymer hose comprising one or more braids.

The tank valves 42 may be multi-functional units including various ports, valves and sensors. The tank valves may each comprise one or more of the group comprising: a shut-off valve, a pressure transducer, a temperature sensor and a pressure relief valve, a first port and a second port.

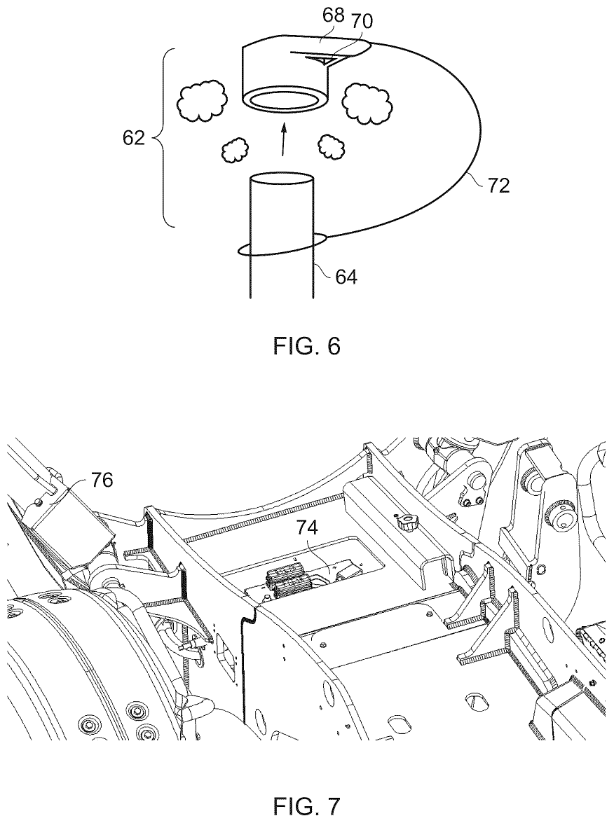

Vent line 64 may terminate with the outlet 62. The outlet 62 may comprise an open end of the vent line 64 and/or may comprise a cap 68. An example of cap 68 is provided in FIG. 6. The cap 68 may be configured to be removable in the event of a predetermined flow of gas escaping from the pressure relief valves 59. In other words, the cap 68 may be attached to the vent line via a pressure responsive attachment, the pressure responsive attachment being configured to detach at a predetermined pressure threshold or flow threshold to provide the high flow configuration.

In some embodiments the cap 68 may comprise a body 68-1 having an aperture in a lower surface in which an end of the vent line 64 can be loosely received. The loose fitting of the cap 68 over the end of the vent line 64 is such that it can be easily blown off when a pressure (or flow rate) exceeds a threshold value, thereby providing a pressure responsive attachment. Once removed, the flow is obstructed only by the internal diameter of the common vent line 64.

Providing a loose fitting cap 68 is also advantageous as it provides a small leakage path for any low level leaks of gas to escape. In some embodiments a low flow leakage path may be provided by a dedicated flow passage. The cap 68 shown in FIG. 6 includes flow passage 70 which allows a flow of gas to be evacuated whilst the cap 68 is in situ and snugly received about the outer diameter of the line 64. The flow passage 70 extends from the internal aperture which receives the vent line 64 to an outlet which is provided in an under surface of the cap 68. The under surface is facing downwards in use, thereby preventing rain or other debris from entering.

The cap 68 may comprise a tether 72 for attaching the cap 68 to the vent line 64 or elsewhere. The tether 72 is flexible and comprises a loop for receiving the vent line 64. In the event of a large escape of gas, the cap 68 may be dislodged from the end of the vent line 64 and left to hang by the tether 72 providing an indication to an operator that there has been an escape of gas, for example, if returning to the machine 10 after a period of absence.

The cap 68 may comprise a bright color such that its presence or removal may be readily observable.

The body 12 is carried by a ground engaging structure 18 comprising propulsive means which are driven by a powertrain. The powertrain comprises by a prime mover and a drivetrain. In this example the prime mover is an internal combustion engine 20 (seen best in FIG. 2) and the drivetrain comprises a powershift gearbox as known in the art, 22 (best seen in FIG. 4), but other prime movers and drivetrain types such as hydrostatic transmission and combinations thereof may be possible.

The body 12 and ground engaging structure 18 are provided in a fixed relation such that there is no relative movement therebetween in normal use. That is, the body 12 is not configured to rotate about a vertical axis, i.e., slew, in relation to the ground engaging structure 18. Further, the body 12 comprises a rigid or fixed frame which does not articulate as a wheeled loading shovel or other machines might.

The body 12 may comprise a chassis 30 which provides the main structural support for the material handling machine 10. The chassis 24 may provide structural support for the ground engaging structure 18, the prime mover 20, the drivetrain, the operator cab 13, the lifting arm 14 and associated actuators, and any ancillary equipment, components, systems or body work as may be required for the machine to function.

The ground engaging structure 18 of the example shown in the figures comprises a front pair of wheels 18F and a rear pair of wheels 18R as well known in the art. The wheels 18F, 18R may be configured to provide two wheel or four wheel steering as well known in the art. As such, either or both of the front and rear wheels may be configured to turn relative to the main body under the influence of a steering device provided within the operator cab 13. The steering device may comprise a steering wheel 26, lever or joystick, for example.

Either or both of the front 18F and rear 18R wheels may be driveably attached to corresponding axles which form part of the transmission/drivetrain of the material handling machine 10. One or both of the axles may be coupled to the prime mover or drive train which is configured to drive movement of one or both pairs of wheels 18F, 18R. Thus, the wheels may contact a ground surface and rotation of the wheels 18F, 18R may cause movement of the machine with respect to the ground surface. In other embodiments the ground engaging propulsion structure comprises tracks. In an embodiment, at least one of the first and second axles is coupled to the machine body 12 by a pivot joint (not shown) located at substantially the center of the axle such that the axle can rock about a longitudinal axis of the machine 10 thereby improving stability when moving across uneven ground.

The operator cab 13 is mounted to the chassis 24 of the main body 12 and includes an operator seat and suitable controls for operating the machine 10. Thus, there may be one or more: steering device, such as a steering wheel 13-7, lever or joystick for example; input devices for operating the lifting arm 14, such as a lever or joystick 13-8 for example, speed control devices for controlling the movement of the machine over ground, such as one or more foot controls (e.g., accelerator, brake), lever or joystick; a throttle control; one or more output devices for providing the operator with information pertaining to the operating state of the machine which may be visual (e.g., a display screen, warning lights) or audible (e.g., buzzer, speaker or other alarm); and, one or more input devices for configuring or operating various aspects of the machine (e.g., switches, levers, touch screen display, joysticks, touch buttons).

The operator cab 13 may be conventional and be constructed from a glazed frame 13 including a number of structural members having panels or glass extending therebetween. The operator cab 13 extends from one side of the machine 10, the near-side, towards the other lifting arm 14.

The lifting arm 14 may be provided by an elongate box section having a length which extends fore-aft on the machine 10, a transverse width, and a vertical depth. The lifting arm 14 may comprise a telescopic boom having a plurality of nested sections which are configured to expand telescopically to adjust the length thereof upon demand. Thus, there is shown a first section 14-1 connected to a pivoting mount 32 and a second section 14-2 which is telescopically mounted within the first section 14-1. The second section 14-2 of the lifting arm 14 is longitudinally moveable with respect to the first section 14-1 such that the lifting arm 14 can be extended and retracted on demand from the operator cab 13 controls. The lifting arm 14 shown in the Figures comprises four telescopic sections but more or fewer may be used in other embodiments. It will be appreciated that the lifting arm may not be telescopic in some embodiments.

The lifting arm 14 extends from the pivot mount 32 which is located generally above the rear wheel 18R and aft of the cab 13 to the front of the machine 10. The tool carrier 16 is the foremost part of the machine when no lifting implement is attached. The first section 14-1 comprises a straight section which is inclined slightly downwards from the pivot mount 32 for transportation and when not in use, and extends fore of the cab 13 to terminate above the front wheel 18F. The second section 14-2 extends colinearly from within the first section with a drop section 14-3 which is angled downwards so as to put the carriage 16 proximate the ground. Telescopic movement of the second section 14-2 with respect to the first section 14-1 of the lifting arm 14 may be achieved by use of an extension actuator 14-4. The extension actuator 14-4 may be any known in the art, such as a double acting hydraulic linear actuator. In some embodiments, extension may be achieved by use of an electric linear actuator, a telescopic extension ram, multiple extension rams, and/or a chain and pulley system.

The material handling machine 10 may comprise a battery 74. The battery provides electrical power for powering various electrical functions on the material handling machine as well known in the art. For example, the battery may provide power to a starter motor of the machine or one or more ECUs or other electrical equipment.

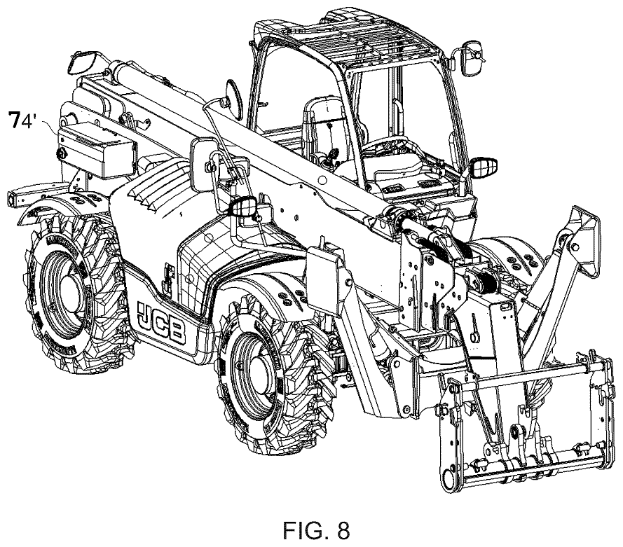

The battery 74 may be located on the machine 10 in an area which is removed from the storage tanks 18a-c and gas engine. The battery 74 may be located within a housing which is provided towards the front of, rear of, upstream of or downstream off and external to the lifting arm housing so as to be suitably removed from the vent lines and storage assembly. In the embodiment shown in FIG. 7, the battery 74 is located in a forward housing of the chassis between conventional stabilizer legs 76 which may be deployed to increase the machine stability during certain lifting operations. The forward housing may comprise first and second chassis walls which extend forward from the lifting arm housing, a base and fore and aft walls and an upper surface which may comprise a removable access panel. The position of the forward housing places the battery below the lifting arm and is readily accessible for maintenance purposes. In another embodiment shown in FIG. 8, the battery may be located on an external surface of the chassis in an appended housing 74′. The housing may be attached to the external surface of the body 12, e.g., the lifting arm housing or chassis side plate, using a plurality of fixings. The exact location of the battery 74 in FIG. 8 may vary, but it may be located aft of the prime mover and local to the boom pivot.

The one or more embodiments are described above by way of example only and it will be appreciated that the various aspects and features may be variously modified. For example, although principally aimed towards material handling machines such as telehandlers, the disclosure may apply to other forms of working machine. These variations are possible without departing from the scope of protection afforded by the appended claims.

1. An off-highway machine comprising:
a body mounted on a ground engaging structure; and
a gas engine;
an array of storage tanks for supplying gaseous fuel to the gas engine, each storage tank comprising a cylinder having a central axis, a first end and a second end, and oriented such that first end of each storage tank is provided on the same side of the array,
wherein each first end of the storage tanks is provided with a tank valve for controlling the flow of gaseous fuel into and out of the respective cylinder,
wherein the tank valves of the respective storage tanks are connected in series flow communication such that a first of the plurality storage tanks comprises a first tank valve inlet in flow communication with a filling nozzle inlet, and a first tank valve outlet is connected to a second tank valve inlet of an adjacent tank in the array of tanks,
wherein the plurality of tank valves each comprise a first port and a second port, each of which being attached to a conduit for receiving or delivering gaseous fuel to or from the storage tank respectively, and
wherein the first and second ports are bi-directional ports which comprise a bi-directional flow passage therebetween which allows gas to flow in either direction along each conduit such that each conduit is configurable as both an inlet conduit and an outlet conduit.

2. The off-highway machine of claim 1, wherein the first port is provided in a first port position and the second port is provided in a second position, wherein the first and second port positions correspond across the plurality of tank valves.

3. The off-highway machine of claim 1, wherein the first port and second port are configurable as an inlet port or an outlet port such that the position of the conduit as an inlet conduit or outlet conduit can be selected.

4. The off-highway machine of claim 3, wherein for a first tank of the array of tanks, the first port is an inlet port and the second port is an outlet port, and for a second tank of the array of tanks which is in adjacent flow communication with the first tank, the first port is an outlet port and the second port is an inlet port.

5. The off-highway machine of claim 4, wherein, directly connected ports of adjacent tanks are provided on corresponding sides of the tank valves.

6. The off-highway machine of claim 1, wherein when there is a plurality of tanks, the directly connected ports of adjacent tanks are provided on corresponding sides of the tank valves.

7. (canceled)

8. The off-highway machine of claim 1, wherein the first tank is proximal to the filling nozzle inlet.

9. The off-highway machine of claim 1, further comprising an outlet regulator connected to the outlet of a final tank in the flow series of the array of tanks, the outlet regulator being proximate to the final tank.

10. The off-highway machine of claim 9, wherein each of the tanks comprise a location feature configured to ensure the tanks and tank valves are mounted in the correct angular orientation relative to one another and, optionally, the correct axial position.

11. The off-highway machine of claim 9, wherein the filling nozzle inlet comprises a filling nozzle configured to receive a corresponding nozzle of a refueling device, wherein the filling nozzle is located behind a hinged door provided in a storage tank housing.

12. (canceled)

13. (canceled)

14. The off-highway machine of claim 1, wherein each tank comprises a temperature dependent pressure relief device, TRPD, the TRPD is optionally provided on the tank valve.

15. The off-highway machine of claim 14, further comprising a tank vent conduit connected to each pressure relief valve of the plurality of storage tanks, the tank vent conduit extending from each respective pressure relief valve to a tank vent outlet remote from the plurality of storage tanks.

16. The off-highway machine of claim 15, wherein each storage tank valve is connected to a common tank vent conduit which terminates with the tank vent outlet.

17. The off-highway machine of claim 16, wherein the TRPD is provided at the same location on each tank.

18. The off-highway machine of claim 15, further comprising an outlet regulator, wherein the outlet regulator comprises a TPRD connected to the tank vent conduit.

19. The off-highway machine of claim 15, wherein the tank vent outlet is provided above the body, optionally above the operator cab.

20. The off-highway machine of claim 19, wherein the tank vent conduit extends from the plurality of storage tanks to the body and/or operator cab and comprises a portion of flexible conduit to allow differential movement of the plurality of storage tanks in relation to the body and/or operator cab.

21. The off-highway machine of claim 15, wherein the vent conduit extends up a wall of the operator cab.

22. The off-highway machine of claim 21, wherein the tank vent conduit extends up a rear wall of the operator cab.

23. The off-highway machine of claim 22, further comprising a working arm, wherein the tank vent conduit is adjacent to the working arm.

24. (canceled)

25. (canceled)
